(19) United States
(12) Patent Application Publication
(10) Pub. No.: US 2026/0241723 A1
(43) Pub. Date: Aug. 20, 2026

(54) PRINTING APPARATUS

(71) Applicant: CANON KABUSHIKI KAISHA, Tokyo (JP)

(72) Inventors: MASAKAZU TSUKUDA, Kanagawa (JP); HIROTAKA ENDO, Kanagawa (JP); KEN TAKENAGA, Kanagawa (JP); MASAAKI MATSUURA, Kanagawa (JP); TOMOYA HARA, Kanagawa (JP); TAKAAKI AOYAGI, Kanagawa (JP)

(21) Appl. No.: 19/544,538

(22) Filed: Feb. 19, 2026

(30) Foreign Application Priority Data
Feb. 20, 2025 (JP) 2025-025833

(51) Int. Cl. B41J 13/10; B41J 13/28

(52) U.S. Cl. CPC B41J 13/106; B41J 13/28

(57) ABSTRACT

A printing apparatus includes: a discharge unit configured to discharge a print medium in a first direction; a stacking unit having a stacking surface and configured to extend and contract in the first direction and to stack the print medium discharged from the discharge unit on the stacking surface; a first regulation unit arranged in the stacking unit, on a downstream side in the first direction of the stacking unit, and configured to regulate a position of a front edge of the print medium discharged from the discharge unit; and a control unit configured to control extension of the stacking unit prior to discharge of the print medium, in accordance with a size of the print medium to be discharged from the discharge unit.

### BACKGROUND

### Field of Technology

The present disclosure relates to a printing apparatus including a stacking part on which discharged print media are stacked.

### Description of the Related Art

In a printing apparatus that discharges print media after printing and stacks them on a stacking part, a technology of stacking print media on an extendable stacking part is known. Japanese Patent Laid-Open No. 2021-70565 discloses extending a stacking part in accordance with the size of a print medium.

However, in the technology disclosed in Japanese Patent Laid-Open No. 2021-70565, print media are stacked across the end portion of the stacking part, and disruption of a stack position is not taken into consideration.

### SUMMARY

The present disclosure has been made in view of the above-mentioned problem, and provides a technology capable of suppressing disruption of a stack position of discharged print media.

A printing apparatus includes: a discharge unit configured to discharge a print medium in a first direction; a stacking unit having a stacking surface and configured to extend and contract in the first direction and to stack the print medium discharged from the discharge unit on the stacking surface; a first regulation unit arranged in the stacking unit, on a downstream side in the first direction of the stacking unit, and configured to regulate a position of a front edge of the print medium discharged from the discharge unit; and a control unit configured to control extension of the stacking unit prior to discharge of the print medium, in accordance with a size of the print medium to be discharged from the discharge unit.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view illustrating the internal configuration of a printing apparatus;

FIG. 2A and FIG. 2B are a front view and plan view of a printing part;

FIG. 3A and FIG. 3B are diagrams describing the conveyance system of the printing part;

FIG. 4 is a block configuration diagram focusing on the control system of a stacking part in the printing part;

FIGS. 5A and 5B are a perspective configuration diagram of the stacking part;

FIG. 6A and FIG. 6B are diagrams describing the range of movement of a front tray;

FIG. 7A and FIG. 7B are diagrams describing the sorting positions of the stacking part;

FIG. 8 is a perspective configuration diagram of a drive transmission part;

FIG. 9 is a perspective configuration diagram of a cam;

FIG. 10A to FIG. 10C are diagrams describing the movement of a reciprocating member using the cam;

FIG. 11 is a diagram describing how the stacking part is driven, depending on the rotation direction of a drive source;

FIG. 12 is a diagram showing a relation between FIGS. 12A and 12B;

FIGS. 12A and 12B are flowcharts illustrating details of processing of print processing;

FIG. 13A to FIG. 13F are diagrams illustrating the states of the stacking part that has been driven during the printing processing;

FIG. 14A to FIG. 14D are diagrams for describing the discharge of print media onto a stacking surface of the stacking part;

FIG. 15 is a diagram describing another configuration for expanding and contracting the stacking part;

FIG. 16 is a diagram describing another configuration for moving the stacking part in the X direction;

FIG. 17A to FIG. 17C are diagrams describing a configuration for sorting print media stacked in the stacking part; and

FIG. 18A and FIG. 18B are diagrams describing another configuration for sorting print media stacked in the stacking part.

### DESCRIPTION OF THE EMBODIMENTS

Hereinafter, with reference to the accompanying drawings, detailed descriptions are given of examples of an embodiment of the printing apparatus. Note that the following embodiments are not intended to limit the present disclosure, and every combination of the characteristics described in the present embodiments is not necessarily essential to the solution provided in the present disclosure. Further, the positions, shapes, etc., of the constituent elements described in the embodiments are merely examples and are not intended to limit the scope of this disclosure thereto.

In the present embodiments, as an example of the printing apparatus, a description is given of a multifunction peripheral that has a printing function for ejecting ink as a printing agent using an inkjet system to perform printing on a print medium and a reading function for reading a document placed on a platen glass. Note that the printing system is not limited to the inkjet system, and may be, for example, electrophotographic system or various other known systems. Printing agents that can be ejected by the printing apparatus according to the present embodiments are not limited to ink, and include various known printing agents used for printing, such as a processing liquid for applying a predetermined treatment to the ejected ink.

In the present specification, viewing from a position facing the side to which print media are discharged after printing, the direction from the left side toward the right side of the printing apparatus is described as the X direction, the direction from the rear side (the back side) toward the near side (the front side) of the printing apparatus is described as the Y direction, and the direction from the lower side toward the upper side of the printing apparatus is described as the Z direction. In this way, the X direction, Y direction, and Z direction are directions from one side toward the other side, and are orthogonal to one another. In the present specification, each direction is represented with a "+ (plus)" in a case where movement is from the one side toward the other side, and with a "− (minus)" in a case where movement is from the other side toward the one side, as appropriate.

### First Embodiment

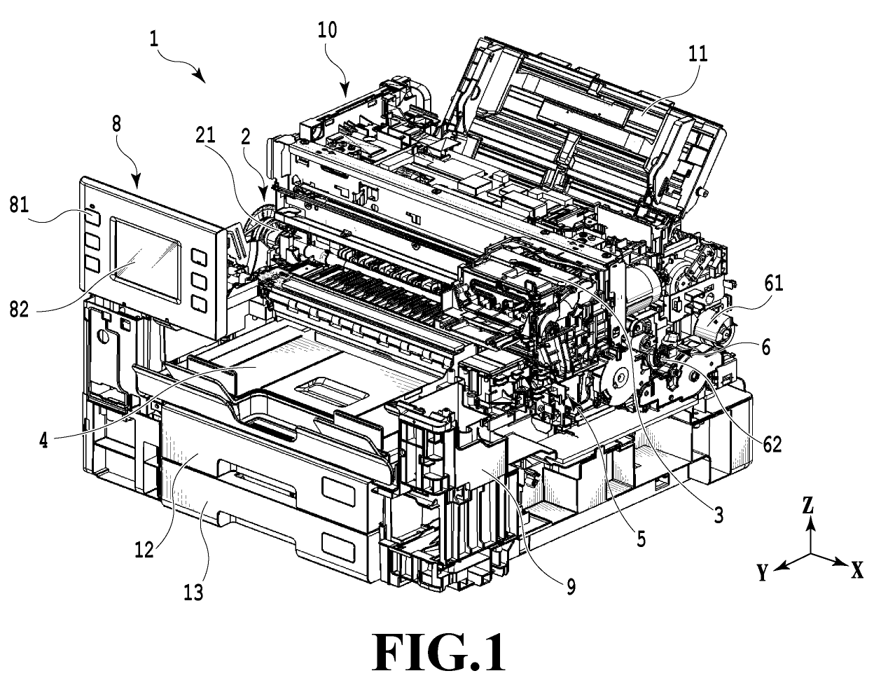

First, with reference to FIG. 1 to FIG. 14E, a description is given about the printing apparatus according to the first embodiment.

### Configuration of the Printing Apparatus

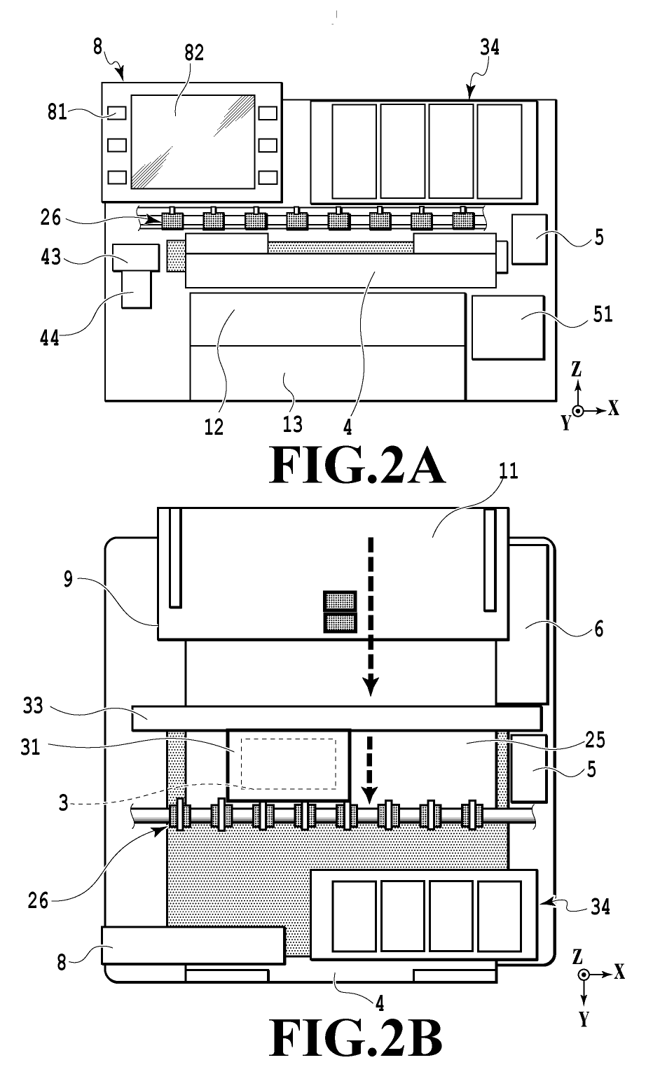

A description is given about the overall configuration of the printing apparatus according to the present embodiment. FIG. 1 is a perspective view of the internal configuration of the printing apparatus. FIG. 2A is a front view of a printing part, and FIG. 2B is a plan view of the printing part. Note that in FIG. 1, illustrations of some configurations are omitted for ease of understanding.

The printing apparatus 1 is a multifunction peripheral including the printing part 10 that performs printing on print media, and a scanner part (not illustrated in the drawings) arranged above the printing part 10 to read documents. In the printing apparatus 1, various processes related to a printing operation and reading operation are executed either individually or cooperatively by the printing part 10 and the scanner part.

The scanner part includes an ADF (automatic document feeder) and an FBS (flatbed scanner) and is capable of reading a document automatically fed by the ADF as well as reading a document placed on the platen glass of the FBS by the user. Note that although the printing apparatus 1 is a multifunction peripheral including the printing part 10 and the scanner part in the present embodiment, a form without the scanner part is also possible.

The printing part 10 includes the first paper feeding part 11, the second paper feeding part 12, and the third paper feeding part 13 for feeding print media (see FIG. 1). Further, the printing part 10 includes the conveyance part 2 that conveys print media fed from each paper feeding part, the print head 3 that performs printing by ejecting ink onto the print media conveyed by the conveyance part 2, and the stacking part 4 for stacking the print media after printing. Furthermore, the printing part 10 includes the maintenance part 5 that performs maintenance of the print head 3, and the drive part 6 that drives the first paper feeding part 11, the second paper feeding part 12, the third paper feeding part 13, and the maintenance part 5.

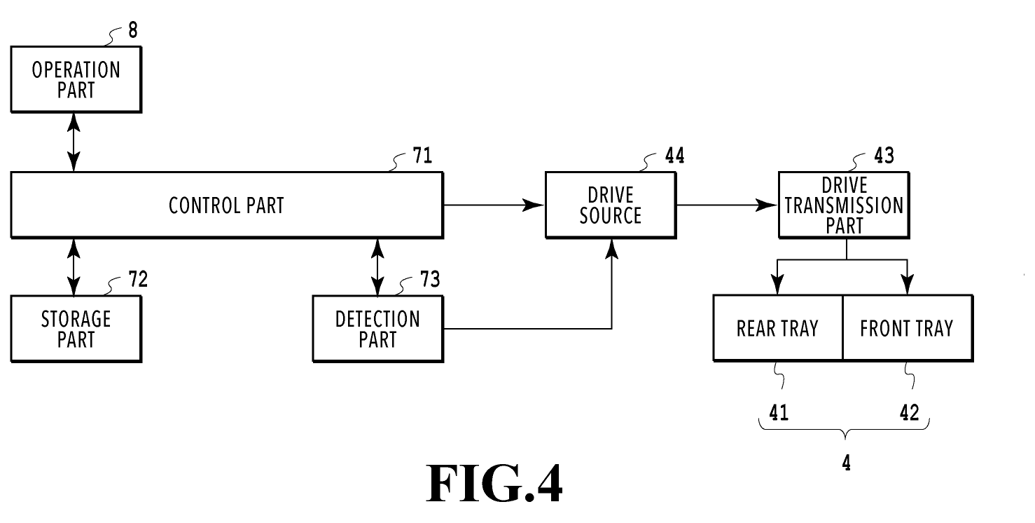

The printing part 10 includes the liquid storage part 34 for storing the ink to be supplied to the print head 3, and the ink discharge part 51 for storing the ink discharged from the maintenance part 5 (see FIG. 2A and FIG. 2B). Further, the printing part 10 includes the control part 71 (see FIG. 4) that controls the overall operation of the printing apparatus 1, such as the control of driving the conveyance part 2, the print head 3, the stacking part 4, and the drive part 6. Furthermore, the printing part 10 includes the operation part 8 capable of receiving input operations by the user and displaying various information. The operation part 8 is equipped with the operation button 81 for inputting operation information to the printing apparatus 1, and the display panel 82 for displaying operation information. In the printing apparatus 1, each of the above-described configurations is fastened to the housing 9 to constitute the printing part 10.

In the printing part 10, the operation part 8 and the liquid storage part 34 are arranged above the stacking part 4. More specifically, the operation part 8 and the liquid storage part 34 are each arranged at positions partially overlapping the stacking part 4 in the XY plane (see FIG. 2B). Note that the operation part 8 and the liquid storage part 34 are arranged with a space from the stacking part 4 in the Z direction (see FIG. 2A). In the present embodiment, the operation part 8 is arranged on one side (the left side) in the X direction, and the liquid storage part 34 is arranged on the other side (the right side) in the X direction. Note that it is also possible that the layout of the operation part 8 and the liquid storage part 34 in the X direction is reversed.

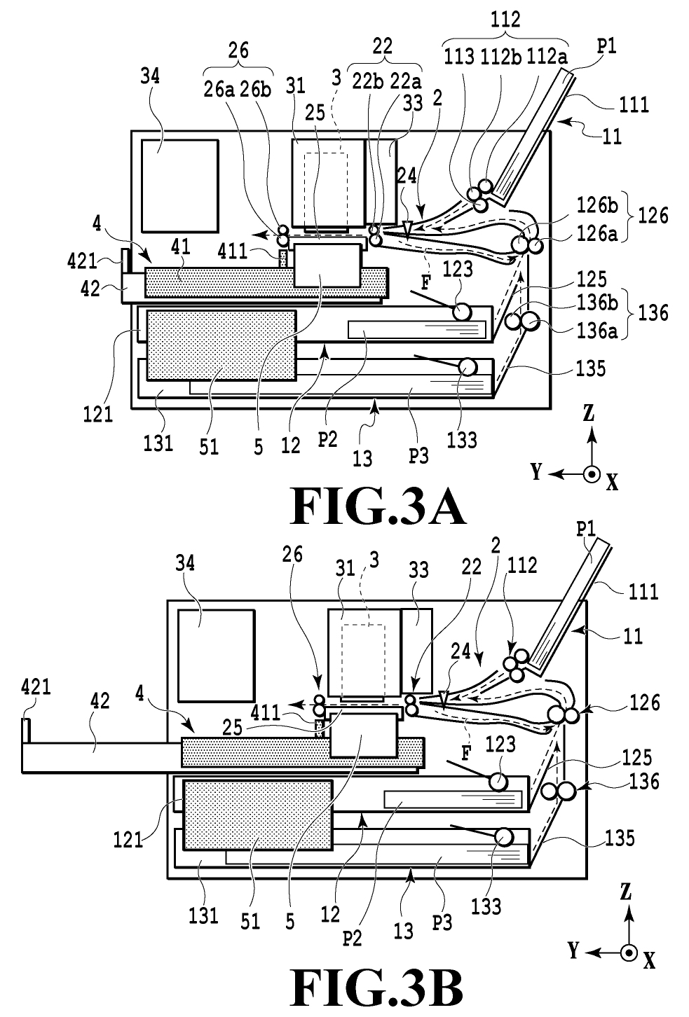

Further, in the printing part 10, the operation part 8 and the liquid storage part 34 are arranged on the other side in the Y direction (the front side) relative to the paper discharge roller pair 26, i.e., on the downstream side in the conveyance direction of print media to be discharged by the paper discharge roller pair 26. Additionally, in the printing part 10, the maintenance part 5 is arranged within the movement area of the print head 3, on the other side of the stacking part 4 in the X direction. More specifically, the maintenance part 5 is arranged at a position partially overlapping with the stacking part 4 in the YZ plane (see FIG. 3A). Furthermore, in the printing part 10, the ink discharge part 51 is arranged below the stacking part 4. More specifically, the ink discharge part 51 is arranged at a position partially overlapping with the stacking part 4 in the XY plane (see FIG. 2A and FIG. 3A).

### Conveyance Part and Paper Feeding Part

Next, a description is given about the configuration of the conveyance system of the printing part 10. FIG. 3A and FIG. 3B are diagrams illustrating the configuration of the conveyance system of the printing part 10, with FIG. 3A illustrating the state before the stacking part 4 expands, and FIG. 3B illustrating the state after the stacking part expands.

### Conveyance Part

The conveyance part 2 includes the conveyance roller pair 22 that conveys the print medium fed from each paper feeding part to the printing position where printing can be performed by the print head 3, and the paper discharge roller pair 26 that discharges the print medium after printing is performed by the print head 3. The conveyance roller pair 22 includes the conveyance roller 22a that is driven by the conveyance motor 21 (see FIG. 1), and the pinch roller 22b that is in pressure contact and associates with the conveyance roller 22a. At the conveyance roller pair 22, the print medium is nipped and conveyed by the conveyance roller 22a and the pinch roller 22b. The paper discharge roller pair 26 includes the paper discharge roller 26a that is driven by the conveyance motor 21, and the spur 26b that is in pressure contact with the paper discharge roller 26a. At the paper discharge roller pair 26, the print medium is nipped and conveyed by the paper discharge roller 26a and the spur 26b. In the present embodiment, the paper discharge roller pair 26 functions as a discharge part that discharges (feeds out) a print medium to the stacking part 4.

Further, the conveyance part 2 includes the first intermediate roller pair 126 that conveys the print media fed from the second paper feeding part 12 and the third paper feeding part 13 to the conveyance roller pair 22, and the second intermediate roller pair 136 that conveys the print medium fed from the third paper feeding part 13 to the first intermediate roller pair 126. The first intermediate roller pair 126 includes the first intermediate roller 126a that is driven by the drive part 6, and the first driven roller 126b that is in pressure contact and associates with the first intermediate roller 126a. At the first intermediate roller pair 126, the print medium is nipped and conveyed by the first intermediate roller 126a and the first driven roller 126b. Further, the second intermediate roller pair 136 includes the second intermediate roller 136a that is driven by the drive part 6, and the second driven roller 136b that is in pressure contact and associates with the second intermediate roller 136a. At the second intermediate roller pair 136, the print medium is nipped and conveyed by the second intermediate roller 136a and the second driven roller 136b.

Note that after the print medium fed from each paper feeding part passes through the detection lever 24 located on the upstream side of the conveyance direction relative to the conveyance roller pair 22, the positions of the left and right front edges of the print medium in the width direction are aligned with the conveyance direction by the conveyance roller pair 22. That is, the skew of the print medium in the conveyance direction is corrected by the conveyance roller pair 22.

### Paper Feeding Part

### First Paper Feeding Part

The first paper feeding part 11 includes the pressure plate 111 on which a print medium is placed, and the first paper feeding roller part 112 that feeds the print medium placed on the pressure plate 111 to the conveyance roller pair 22. The first paper feeding roller part 112 includes the first paper feeding rollers 112a and 112b that feed the print medium to the conveyance roller pair 22. Further, the first paper feeding roller part 112 includes the separation roller 113 that is arranged at a position opposed to the first paper feeding roller 112b and applies resistance to the print medium fed by the first paper feeding roller 112b. The first paper feeding rollers 112a and112b are driven by the driving force of the driving motor 61 (see FIG. 1) of the drive part 6.

In the first paper feeding part 11, the print medium P1 stacked on the pressure plate 111 abuts on the first paper feeding roller 112a, which rotates under the driving of the driving motor 61, thereby starting the feeding of the print medium P1. The print medium P1 fed by the first paper feeding roller 112a is fed by the first paper feeding roller 112b, which is arranged on the downstream side in the feeding direction relative to the first paper feeding roller 112a. At this time, only the topmost sheet of the print media P1 fed by the first paper feeding roller 112b is fed to the conveyance roller pair 22 by the separation roller 113, which is arranged at the position opposed to the first paper feeding roller 112b.

### Second Paper Feeding Part

The second paper feeding part 12 includes the cassette case 121 that accommodates a print medium, the second paper feeding roller 123 that feeds the print medium accommodated in the cassette case 121, and the separation part 125 that applies resistance to the print medium fed by the second paper feeding roller 123. The second paper feeding roller 123 is driven by the driving force of the driving motor 62 of the drive part 6 (see FIG. 1) transmitted through a gear train (not illustrated in the drawings).

In the second paper feeding part 12, upon driving of the driving motor 62, the second paper feeding roller 123 rotates while abutting on the print medium P2 accommodated in the cassette case 121, thereby starting the feeding of the print medium P2 to the first intermediate roller pair 126. To the print medium P2 fed by the second paper feeding roller 123, resistance against the feeding direction is applied by the separation part 125. Accordingly, even if multiple print media P2 are fed by the second paper feeding roller 123, only the topmost sheet of the print media P2 is fed to the first intermediate roller pair 126 by the separation part 125. The print medium P2 fed to the first intermediate roller pair 126 is conveyed to the conveyance roller pair 22 by the first intermediate roller pair 126.

### Third Paper Feeding Part

The third paper feeding part 13 includes the cassette case 131 that accommodates a print medium, the third paper feeding roller 133 that feeds the print medium accommodated in the cassette case 131, and the separation part 135 that applies resistance to the print medium fed by the third paper feeding roller 133. The third paper feeding roller 133 is driven by the driving force of the driving motor 62 of the drive part 6 (see FIG. 1) transmitted through a gear train (not illustrated in the drawings).

In the third paper feeding part 13, upon driving of the driving motor 62, the third paper feeding roller 133 rotates while abutting on the print medium P3 accommodated in the cassette case 131, thereby starting the feeding of the print medium P3 to the second intermediate roller pair 136. To the print medium P3 fed by the third paper feeding roller 133, resistance against the feeding direction is applied by the separation part 135. Accordingly, even if multiple print media P3 are fed by the third paper feeding roller 133, only the topmost sheet of the print media P3 is fed to the second intermediate roller pair 136 by the separation part 135. The print medium P3 fed to the second intermediate roller pair 136 is conveyed to the conveyance roller pair 22 by the second intermediate roller pair 136 and the first intermediate roller pair 126.

### Print Head

Next, a description is given about the print head 3. In the printing part 10, the print head 3 is supported in a slidable manner on the chassis 33 extending in the X direction, and is mounted on the carriage 31 configured to be capable of reciprocal movement in the X direction (see FIG. 2B and FIG. 3A). Accordingly, the print head 3 is able to move reciprocally in the X direction via the carriage 31. The print medium conveyed by the conveyance roller pair 22 is supported by the platen 25 placed at the position opposed to the print head 3. Further, while moving in the X direction via the carriage 31, the print head 3 ejects ink onto the print medium supported by the platen 25 to perform printing.

In a case where printing is performed only on one side of the print medium, the print medium after printing is discharged to the stacking part 4 via the paper discharge roller pair 26. On the other hand, in a case where printing is performed on both sides of the print medium, the conveyance motor 21 is rotated in the reverse direction with the rear edge of the print medium, after printing on one side, being nipped by the paper discharge roller pair 26. Accordingly, the paper discharge roller pair 26 and the conveyance roller pair 22 rotate in the direction opposite to the rotation for conveying the print medium in the conveyance direction, so as to convey the print medium nipped at the rear edge by the paper discharge roller pair 26 to the reversal conveying path F. In the description provided herein, it is assumed that the rear edge of a print medium refers to the rear edge of a print medium in the conveyance direction (+Y direction), and the front edge of a print medium refers to the front edge of a print medium in the conveyance direction.

Then, once the front edge of the print medium conveyed to the reversal conveying path F passes through the conveyance roller pair 22, the conveyance motor 21 is switched to forward rotation. After that, upon passing through the detection lever 24 due to conveyance by the first intermediate roller pair 126, skew correction is performed again by the conveyance roller pair 22. Subsequently, the same operation as that for printing on one side of the print medium is performed, so that after printing on the other side of the print medium, the print medium printed on both sides is discharged to the stacking part 4 by the paper discharge roller pair 26.

Note that, although details are described later, in the present embodiment, the stacking part 4 where the print media discharged via the paper discharge roller pair 26 are stacked automatically expands in the +Y direction during printing (see FIG. 3B). Accordingly, the stacking part 4, most of which is inside the housing 9 before expansion, protrudes outside the housing 9, thereby ensuring the area to stably stack the discharged print media. Note that the stacking part 4 is detachable from the housing 9. By removing the stacking part 4 from the housing 9, the user can insert their hand into the housing 9 to remove a jammed print medium in the conveyance path.

### Stacking Part

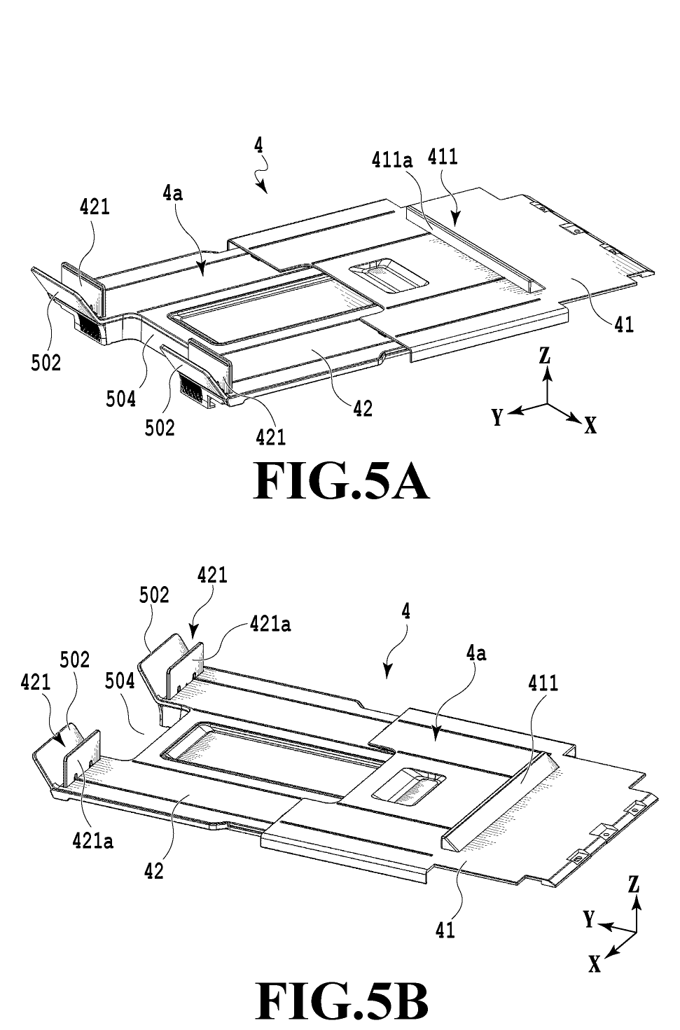

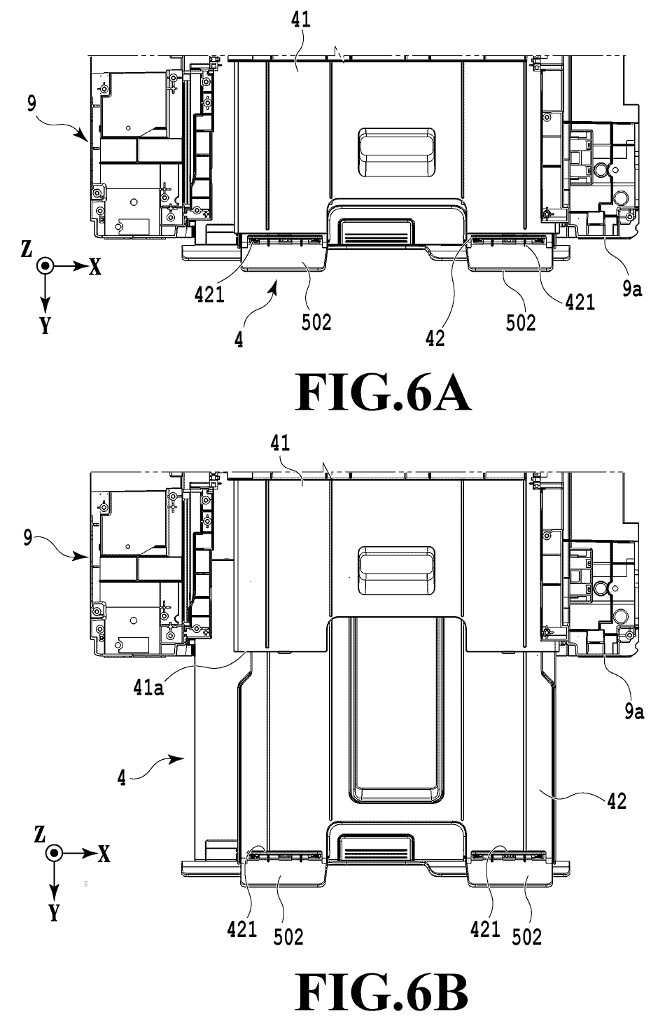

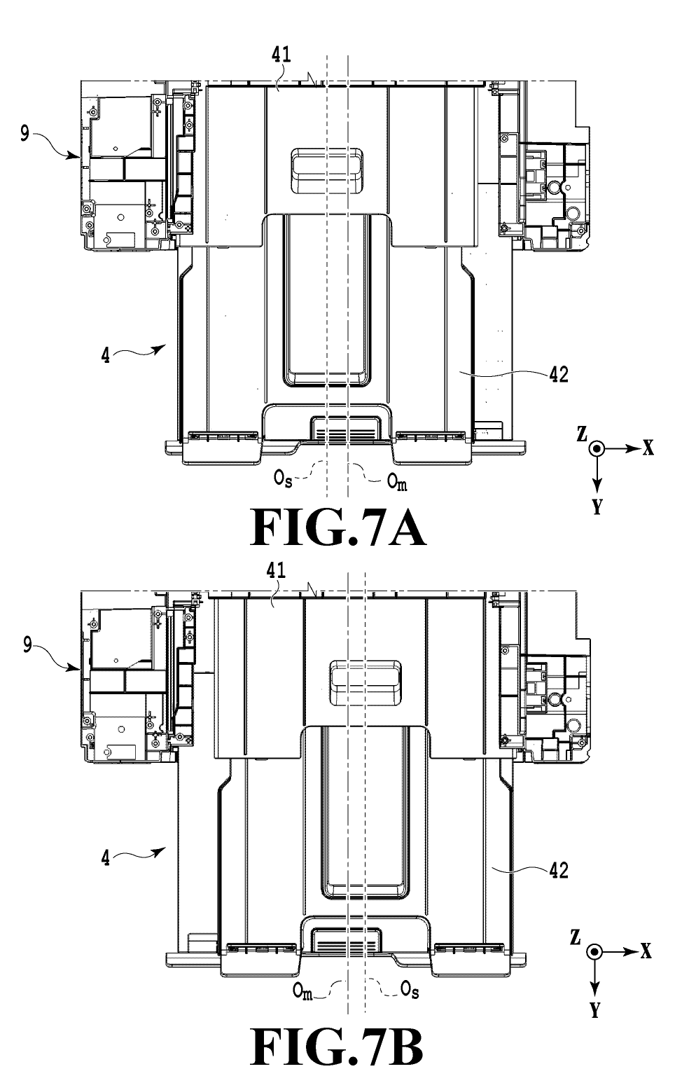

Next, a description is given about the stacking part 4. FIG. 4 is a block diagram illustrating the configuration of the control system of the printing apparatus 1. Note that, to focus on the stacking part 4 in the following description, the control configuration related to the stacking part 4 is mainly illustrated in FIG. 4, and other configurations are omitted. FIG. 5A and FIG. 5B are schematic configuration diagrams of the stacking part 4, with FIG. 5A being a perspective view seen diagonally from the front-side upper right, and FIG. 5B being a perspective view seen diagonally from the rear-side upper right. FIG. 6A and FIG. 6B are diagrams illustrating the positions of the stacking part 4 after expansion and after contraction, with FIG. 6A illustrating the accommodated position of the front tray 42 after the stacking part 4 contracts, and FIG. 6B illustrating the stack position of the front tray 42 after the stacking part 4 expands. FIG. 7A and FIG. 7B are diagrams illustrating two sorting positions of the stacking part 4, with FIG. 7A illustrating the first sorting position, and FIG. 7B illustrating the second sorting position.

The stacking part 4 for stacking the print media discharged by the paper discharge roller pair 26 automatically expands upon the start of printing, thereby expanding the area that supports the discharged print media. Further, upon removal of the print media from the stacking part 4, the stacking part 4 automatically contracts, thereby reducing that area. Furthermore, the stacking part 4 has a function to move in a direction (the X direction) intersecting (orthogonally in the present embodiment) with the expansion and contraction direction (the Y direction) to sort the discharged print media. Note that the automatic contraction of the stacking part 4 in the printing part 10 is executed not only upon removal of the print media from the stacking part 4 but also upon receiving an instruction from the user via the operation part 8, upon absence of a printing operation for a predetermined time, upon switching to a low power mode, or the like.

The printing part 10 includes the control part 71, the storage part 72, the detection part 73, the operation part 8, the stacking part 4, the drive transmission part 43, and the drive source 44 (see FIG. 4).

During the time after receiving a printing command until the print medium is conveyed and discharged onto the stacking part 4, the control part 71 controls the stacking part 4 to complete the movement in the X direction and the expansion in the Y direction. Further, if the print media are removed from the stacking part 4, the control part 71 controls the stacking part 4 to start moving in the X direction and contracting in the Y direction. Although details are described later, the stacking part 4 is expanded after moving in the X direction to the first sorting position (which is described later). In the expansion of the stacking part 4, the front tray 42 that constitutes the stacking part 4 moves from the accommodated position (which is described later) to the stack position (which is described later). Further, the stacking part 4 is contracted after moving in the X direction to the second sorting position (which is described later) that is different from the first sorting position. In the contraction of the stacking part 4, the front tray 42 that constitutes the stacking part 4 moves from the stack position to the accommodated position. With this control, during discharge of a print medium, it is possible to reduce the influence of external force imposed on print media due to the movement of the stacking part 4. That is, it is possible to suppress deterioration in the alignment of the print media discharged and stacked, and thus while sorting print media, the visibility of the sorted print media is improved. Further, since the stacking part 4 automatically expands and contracts, there is no burden on the user, enhancing usability. Note that details of the driving control for the movement and expansion of the stacking part 4 by the control part 71 are described later.

The operation part 8 includes the operation button 81 and the display panel 82 (see FIG. 1). By operating the operation part 8, the user can select whether or not sorting of print media is required and issue an instruction for moving the stacking part 4. Note that in the printing part 10, sorting of print media and movement of the stacking part 4 can also be executed based on information set in a job, for example. The storage part 72 stores various programs for operating the stacking part 4. Upon input from the user through the operation part 8, the control part 71 reads the program corresponding to the input result to perform control of driving the stacking part 4. Further, the storage part 72 holds detection results from the detection part 73.

The detection part 73 includes multiple sensors. Specifically, a sensor that detects the rotation of the drive source 44 (see FIG. 2A) for driving the stacking part 4 is included. The sensor is configured with a rotary encoder and is installed on the rotary axis of the drive source 44 that generates a rotational driving force. The sensor converts the rotational angle of the drive source 44 into a number of steps and transmits it to the control part 71. The control part 71 reads, from the storage part 72, the number of steps required for a predetermined operation of the stacking part 4, and in a case where the number of steps transmitted from the sensor reaches the specified number of steps, the control part 71 determines that the predetermined operation of the stacking part 4 is completed and stops the drive source 44. In the present embodiment, the sensor is configured with an encoder installed on the rotary axis of the drive source 44; however, there is no such limitation. For example, installation on the rotary axis of a predetermined transmission member that constitutes the drive transmission part 43 (see FIG. 2A), which transmits the driving force of the drive source 44 to the stacking part 4, is also possible.

Further, the detection part 73 includes a sensor that detects the position of the stacking part 4 after the predetermined operation. As this sensor, for example, a mechanical switch, a photo sensor, or the rotary encoder of the drive source 44 may be used. Furthermore, the detection part 73 includes a sensor that detects whether or not any print medium is stacked on the stacking part 4. With this sensor, it is possible to detect the timing to contract the stacking part 4.

The stacking part 4 includes the rear tray 41 and the front tray 42 (see FIGS. 5A and 5B). The rear tray 41 is configured to be capable of reciprocal movement in the X direction, which intersects with the direction (the +Y direction) in which print media are discharged. The rear tray 41 is arranged within the housing 9, and the other end portion 41a in the Y direction is arranged further back in the Y direction relative to the front surface 9a of the housing 9 (see FIG. 6B).

The rear tray 41 includes the rear-edge regulation part 411 that protrudes upward on the stacking surface 4a of the stacking part 4 on which print media are stacked, thereby regulating movement of stacked print media in the −Y direction (toward the rear side). The rear-edge regulation part 411 extends in the X direction and includes the abutting surface 411a on which the rear edge (the upstream edge in the +Y direction) of print media to be stacked can abut. The abutting surface 411a is formed, for example, to be perpendicular to the stacking surface 4a, and, in the present embodiment, is a surface parallel to the XZ plane. In the present embodiment, the rear-edge regulation part 411 is located directly below the paper discharge roller pair 26, in other words, on the lower side in the vertical direction (see FIG. 3A and FIG. 3B). For example, the abutting surface 411a may be located on the lower side in the vertical direction with respect to the rotational center of the paper discharge roller 26a. Further, in the present embodiment, the rear tray 41 is configured to be movable in the X direction, but not in the Y direction. Accordingly, the configuration is such that the position of the rear-edge regulation part 411 (the abutting surface 411a) does not change in the Y direction.

The front tray 42 is supported by the rear tray 41 and is configured to be capable of reciprocal movement in the Y direction in the rear tray 41. Accordingly, the front tray 42 is able to reciprocally move in the X direction via the rear tray 41. The front tray 42 includes the front-edge regulation parts 421 that protrude upward near the end portion on the other side (the front side) in the Y direction, thereby regulating movement of stacked print media in the +Y direction. That is, the front-edge regulation parts 421 are erected on the stacking surface 4a of the stacking part 4, near the downstream end portion of the stacking part 4 in the extending direction (+Y direction). Each front-edge regulation parts 421 each includes the abutting surface 421a on which the front edge (the downstream edge in the +Y direction) of print media to be stacked can abut. The abutting surfaces 421a are formed, for example, to be perpendicular to the stacking surface 4a, and, in the present embodiment, are surfaces parallel to the XZ plane.

The front tray 42 includes, at the other end portion in the Y direction, the two angled parts 502 extending at an angle diagonally upward toward the front side, and the notch part 504 formed between the two angled parts. The front-edge regulation parts 421 are erected on the stacking surface 4a of the front tray 42 on which print media to be discharged are stacked, and the angled parts 502 are located on the front side of the front-edge regulation parts 421. The angled parts 502 are formed to regulate the movable range of the front-edge regulation parts 421. The front-edge regulation parts 421 are configured so as not to be damaged even if the user touches and pushes the front-edge regulation parts 421 while removing the print media stacked on the stacking part. Note that the two angled parts 502 and the notch part 504 may be omitted in the front tray 42.

The front-edge regulation parts 421 are formed at two locations corresponding to the two angled parts 502a at the front end portion of the front tray 42. That is, the front-edge regulation parts 421 are formed at the front end portion of the front tray 42 with a space therebetween in the X direction. Note that the number of locations of the front-edge regulation parts 421 is not limited to two. For example, at the front end portion of the front tray 42, instead of forming the notch part 504, front-edge regulation parts 421 may be formed at three or more locations along the X direction, or one front-edge regulation part 421 extending over the entire area in the X direction may be formed.

The front tray 42 is configured to be movable between the accommodated position and the stack position (see FIG. 6A and FIG. 6B). The accommodated position is such that most of the front tray 42 overlaps with the rear tray 41 in the XY plane and is accommodated below the rear tray 41 (see FIG. 6A). The stack position is a position drawn out from the accommodated position so that the front tray 42 cooperates with the rear tray 41 to be able to stack print media (see FIG. 6B). That is, at the time the stacking part 4 expands, the front tray 42 moves in the +Y direction from the accommodated position to the stack position. Further, at the time the stacking part 4 contracts, the front tray 42 moves in the −Y direction from the stack position to the accommodated position. Note that, in the present embodiment, in the accommodated position, a partial area on the front side of the front tray 42 including the angled parts 502 and the front-edge regulation parts 421 protrudes in the Y direction relative to the front surface 9a of the housing 9 (see FIG. 6A). With this configuration, at the time the front tray 42 is in the accommodated position, most of the stacking part 4 is positioned inside the housing 9, thereby reducing the installation space of the printing apparatus 1.

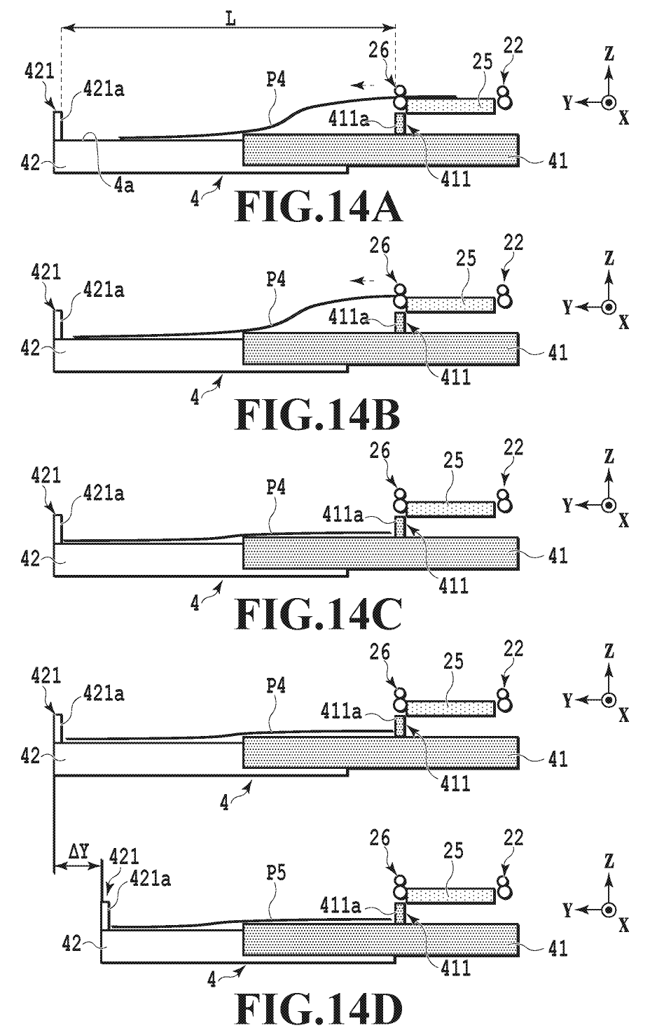

Regarding the stack position, multiple different positions can be taken in the Y direction according to the size of the print media. Specifically, the stack position is set such that the length L (see FIG. 14A) from the paper discharge roller pair 26 to the abutting surfaces 421a of the front-edge regulation parts 421 in the Y direction substantially matches the size (the length in the Y direction) of the print medium to be used. Note that the stack position may be set such that the length L from the abutting surface 411a of the rear-edge regulation part 411 to the abutting surfaces 421a of the front-edge regulation parts 421 in the Y direction substantially matches the length in the Y direction of the print medium to be used. Substantially matching the size of the print medium includes not only matching the length of the print medium in the Y direction, but also includes matching within a predetermined range. Note that it is preferable that the length L from the paper discharge roller pair 26 (the abutting surface 411a) to the abutting surfaces 421a is longer than the length of the print medium in the Y direction by a predetermined amount. The predetermined amount is, for example, a value greater than 0 mm and equal to or less than 10 mm.

In the present embodiment, the stack position includes four positions corresponding to the standard sizes of A4, A5, B5, and LETTER. The positions that can be taken as a stack position are not limited to these four positions. In the present embodiment, for example, these four positions are used as references and are changed depending on the environment in which the printing apparatus is used, the type of print medium, the printing pattern (the application amount of ink), and the like.

If the print medium is in a high humidity environment or if the printing pattern involves application of a large amount of ink to the print medium, the print medium may absorb liquid (water) or swell and expand, resulting in an increase in length in the Y direction. On the other hand, if the print medium is in a low humidity environment or if the pattern involves application of a little amount of ink to the print medium, the moisture inside the print medium is lost and the print medium shrinks, resulting in a decrease in length in the Y direction.

Therefore, the stack position corresponding to the size of the print medium may be changed depending on the environment in which the printing apparatus 1 is used, the amount of ink applied to the print medium based on the printing pattern, or the like. The environment in which the printing apparatus 1 is used is detected by, for example, a temperature and humidity sensor (not illustrated in the drawings) installed in the printing apparatus 1. Further, the printing pattern (the amount of ink applied to the print medium) is acquired, for example, from print data indicating ejection/non-ejection of ink, which is generated based on input image data in an image processing unit provided in the printing apparatus 1.

That is, in a high humidity environment or if the printing pattern involves application of a large amount of ink to the print medium, the stack position is moved in the +Y direction from the position corresponding to the size of the print medium to be used. That is, in this case, the stack position is changed in the direction in which the extension amount of the front tray 42 increases. On the other hand, in a low humidity environment or if the pattern involves application of a small amount of ink to the print medium, the stack position is moved in the −Y direction from the position corresponding to the size of the print medium to be used. That is, in this case, the stack position is changed in the direction in which the extension amount of the front tray 42 decreases.

Further, resin-coated paper designed for photography printing is less susceptible to changes due to the usage environment or printing pattern. On the other hand, paper made from cellulose tends to expand and become longer in length upon absorbing water. Therefore, in a case of using a print medium such as resin-coated paper as described above, which is unlikely to change in size due to the usage environment or the application amount of ink, the stack position is not changed. Further, in a case of using a print medium such as paper made of cellulose, which is prone to size changes depending on the usage environment and the application amount of ink, the stack position is moved toward the +Y direction from the position corresponding to the size of the print medium to be used. That is, in this case, the stack position is changed in the direction in which the extension amount of the front tray 42 increases. Note that, in the following explanation, for ease of understanding, a description is given about the case in which the stack position corresponding to the size of the print medium does not change depending on the usage environment and the application amount of ink.

Further, by the movement of the rear tray 41 in the X direction, the stacking part 4 is configured to be movable between two sorting positions for sorting the print media to be discharged. That is, in the X direction, the stacking part 4 can move between the first sorting position where the center position Os of the stacking part 4 is positioned on one side of the center position Om of the print media to be discharged (see FIG. 7A) and the second sorting position where the center position Os is positioned on the other side of the center position Om (see FIG. 7B). The stacking part 4 is configured to be capable of sorting the print media to be discharged at the positions offset from each other in the X direction by stacking the print media at the first sorting position and stacking the print media at the second sorting position. In other words, the first sorting position and the second sorting position are positioned a predetermined distance apart from each other in the X direction.

In the present embodiment, the distance from the center position Os to the center position Om at the first sorting position may be designed to match the distance from the center position Os to the center position Om at the second sorting position. Alternatively, it is also possible that the distance from the center position Os to the center position Om at the first sorting position is designed to differ from the distance from the center position Os to the center position Om at the second sorting position. The distance required for sorting, i.e., the distance between the first sorting position and the second sorting position, is set to be, for example, 30 mm or more and 50 mm or less. The positions where the stacking part 4 can stay are not limited to the first sorting position and the second sorting position. For example, it is also possible to adopt a configuration in which the stacking part 4 is positioned at the center position Om in a case where sorting is not performed during print processing, in a case where printing is not performed, or the like. For example, the configuration may be such that, in a case where sorting of print media is not performed during print processing or in a case where printing is not performed, the stacking part 4 is positioned at the center position where the center position Os overlaps with the center position Om.

### Drive Transmission Part

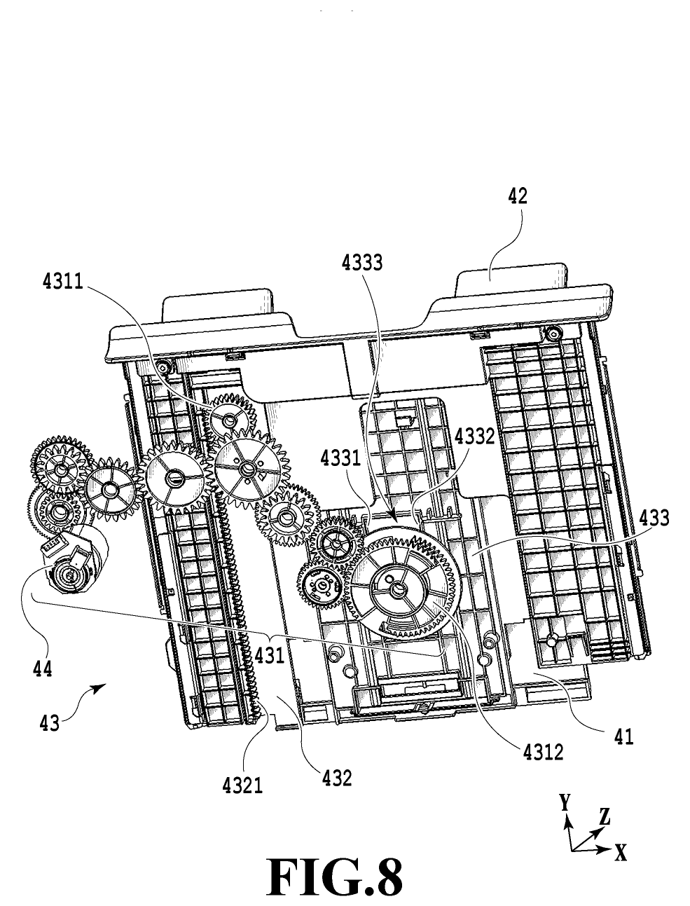

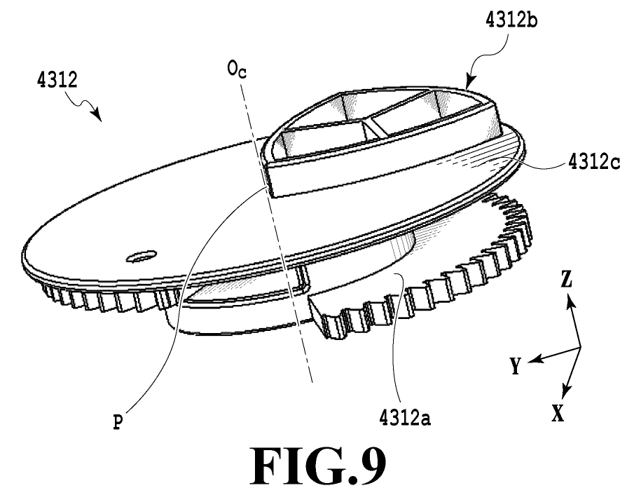

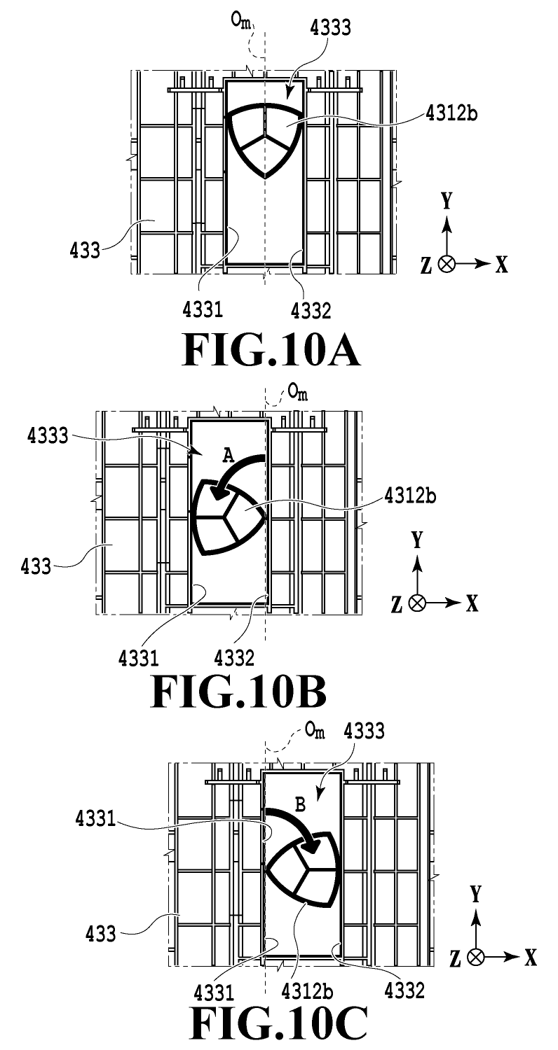

Next, a description is given of the drive transmission part 43. FIG. 8 is a perspective view of the drive transmission part 43. FIG. 9 is a perspective view of the cam, which is a constituent member of the drive transmission part 43. FIG. 10A to FIG. 10C are diagrams describing the movement of the stacking part 4 in the X direction using the cam.

The drive transmission part 43 includes the drive train 431 configured with multiple drive transmission members that transmit the rotational driving force from the drive source 44, and the support member 432 that can move in the Y direction by the driving force transmitted via the drive train 431 (see FIG. 8). Further, the drive transmission part 43 includes the reciprocating member 433 that is capable of moving in the X direction by the driving force transmitted via the drive train 431, and a casing (not illustrated in the drawings) that holds the drive source 44 and the drive train 431.

The support member 432 includes the rack part 4321 that extends in the Y direction. This rack part 4321 meshes with the pinion 4311, which is one of the drive transmission members that constitute the drive train 431, thereby allowing the support member 432 to move in the Y direction by the driving force transmitted from the drive train 431. Specifically, the drive train 431 is configured with multiple gears, including the pinion 4311. The driving force transmitted from the drive source 44 is transmitted to the pinion 4311 via a predetermined gear in the drive train 431, causing the support member 432 to move in the Y direction due to the driving force transmitted to the pinion 4311.

One end of the drive train 431 is connected to the drive source 44. Further, at the other end of the drive train 431, the cam 4312 that engages with the reciprocating member 433 is positioned. The cam 4312 includes the circular plate part 4312c, the gear part 4312a formed on one surface of the plate part 4312c, and the cam part 4312b formed on the other surface of the plate part 4312c (see FIG. 9). The driving force from the drive source 44 is transmitted to the gear part 4312a, thereby causing the cam 4312 to rotate about the rotational center, i.e., the axis Oc that passes through the center of the plate part 4312c and is parallel to the Z direction. In the present embodiment, the cam part 4312b has a substantially triangular cylindrical shape, and each side connecting adjacent vertices of the triangle is gently curved to protrude outward (see FIG. 10A). Further, the cam part 4312b is formed on the other surface of the plate part 4312c eccentrically with respect to the rotational center such that the predetermined vertex P is positioned on the axis Oc.

The reciprocating member 433 has the engagement part 4333 formed to engage with the cam part 4312b. The engagement part 4333 has the first sliding surface 4331 and the second sliding surface 4332 which are formed to face each other with a predetermined space in the X direction such that the engaging cam part 4312b can slide therein. Note that the predetermined space corresponds to the length of the cam part 4312b in the X direction. Further, the first sliding surface 4331 and the second sliding surface 4332 are formed parallel to the Y direction. As mentioned above, the cam part 4312b is eccentric with respect to the rotational center of the cam 4312. Accordingly, if the cam 4312 rotates, the cam part 4312b slides on the first sliding surface 4331 or the second sliding surface 4332, thereby moving the reciprocating member 433 in the +X direction or −X direction (see FIG. 10A to FIG. 10C).

For example, assume that, by a rotation of the cam 4312, the cam part 4312b has rotated from a predetermined position (the position illustrated in FIG. 10A) in the direction of arrow A (see FIG. 10B). In this case, the cam part 4312b slides on the first sliding surface 4331, thereby moving the reciprocating member 433 to one side (the −X direction) from the other side in the X direction (see FIG. 10B). Further, assume that, by a rotation of the cam 4312, the cam part 4312b has rotated from a predetermined position in the direction of arrow B (see FIG. 10C). In this case, the cam part 4312b slides on the second sliding surface 4332, thereby moving the reciprocating member 433 from one side to the other side (+X direction) in the X direction (see FIG. 10C).

The support member 432 is connected to the front tray 42. Therefore, in conjunction with the movement of the support member 432 in the Y direction, the front tray 42 moves in the Y direction. Further, the reciprocating member 433 is connected to the rear tray 41. Therefore, in conjunction with the movement of the reciprocating member 433 in the X direction, the rear tray 41 moves in the X direction, and the front tray 42 also moves in the X direction via the rear tray 41. In the present embodiment, the support member 432 is connected to the front tray 42 and the reciprocating member 433 is connected to the rear tray 41; however there is no such limitation. For example, the rack part 4321 may be formed on the front tray 42, allowing the front tray 42 to have the function of the support member 432, or the engagement part 4333 may be formed on the rear tray 41, allowing the rear tray 41 to have the function of the engagement part 4333.

### Overview of the Movements of the Rear Tray and the Front Tray

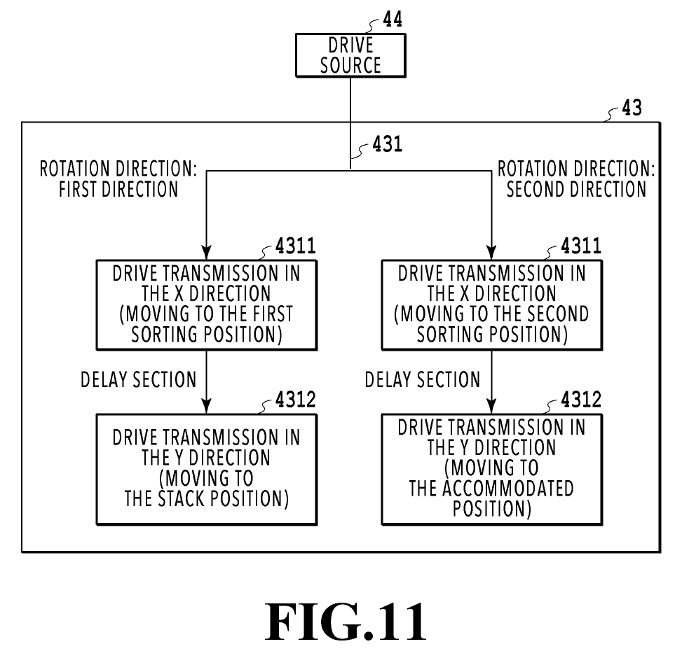

Next, a description is given of an overview of the movements of the rear tray 41 and the front tray 42. FIG. 11 is a diagram illustrating an overview of the movements of the rear tray 41 and the front tray 42.

In the drive train 431, a delay section is formed in the drive transmission path for the Y direction. Specifically, the drive train 431 is configured to start the movement of the front tray 42 in the Y direction after the movement of the rear tray 41 in the X direction is completed. More specifically, in a case where the rotation direction of the drive source 44 is in the first direction, the rear tray 41 is moved to the first sorting position, and the front tray 42 is also moved to the first sorting position via the rear tray 41. Subsequently, the drive source 44 is further rotated in the first direction, thereby expanding the front tray 42 relative to the rear tray 41, that is, the front tray 42 in the accommodated position is moved in the +Y direction to the stack position. In a case where the rotation direction of the drive source 44 is the second direction, which is opposite to the first direction, the rear tray 41 is moved to the second sorting position, and the front tray 42 is also moved to the second sorting position via the rear tray 41. Subsequently, the drive source 44 is further rotated in the second direction, thereby contracting the front tray 42 relative to the rear tray 41, that is, the front tray 42 in the stack position is moved in the −Y direction to the accommodated position.

In the present embodiment, the drive transmission part 43 moves the front tray 42 in the Y direction after moving the rear tray 41 in the X direction; however, there is no such limitation. For example, it is also possible to move the rear tray 41 in the X direction after moving the front tray 42 in the Y direction. Further, various known transmission mechanisms, such as a link mechanism, may be used as a configuration for transmitting the driving force of the drive source 44. Furthermore, the printing part 10 may include multiple drive sources, so that the movement of the rear tray 41 in the X direction and the movement of the front tray 42 in the Y direction are executed by the driving force from different drive sources. Note that the movement of the rear tray 41 in the X direction and the movement of the front tray 42 in the Y direction may be executed not only by the drive source 44 but also manually by the user.

### Print Processing

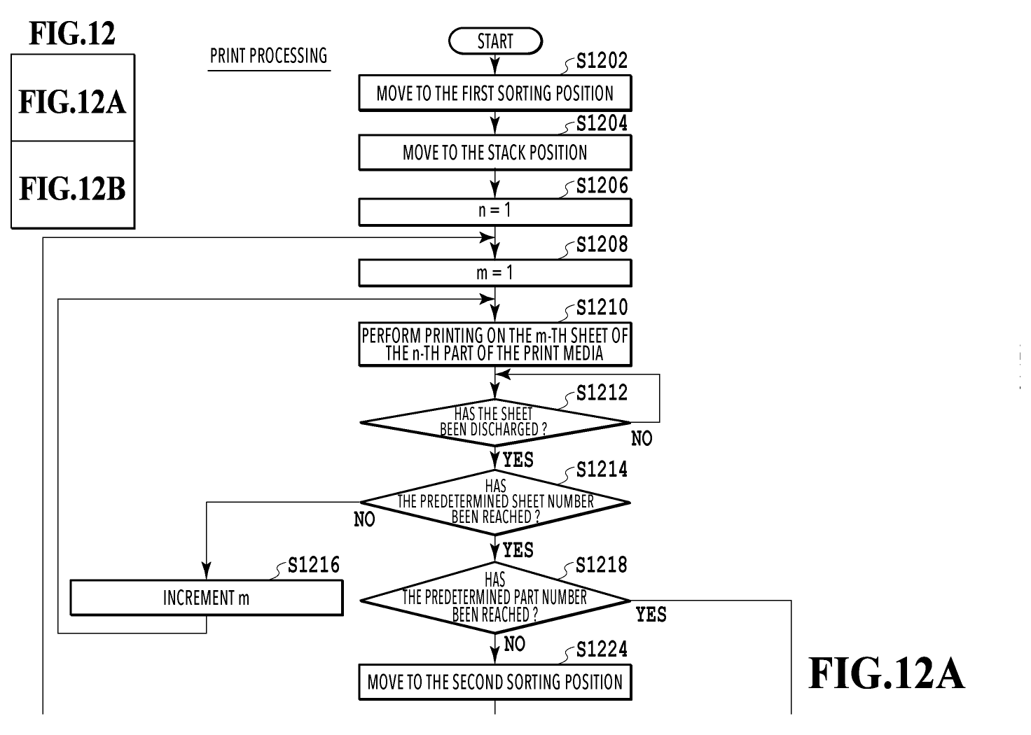

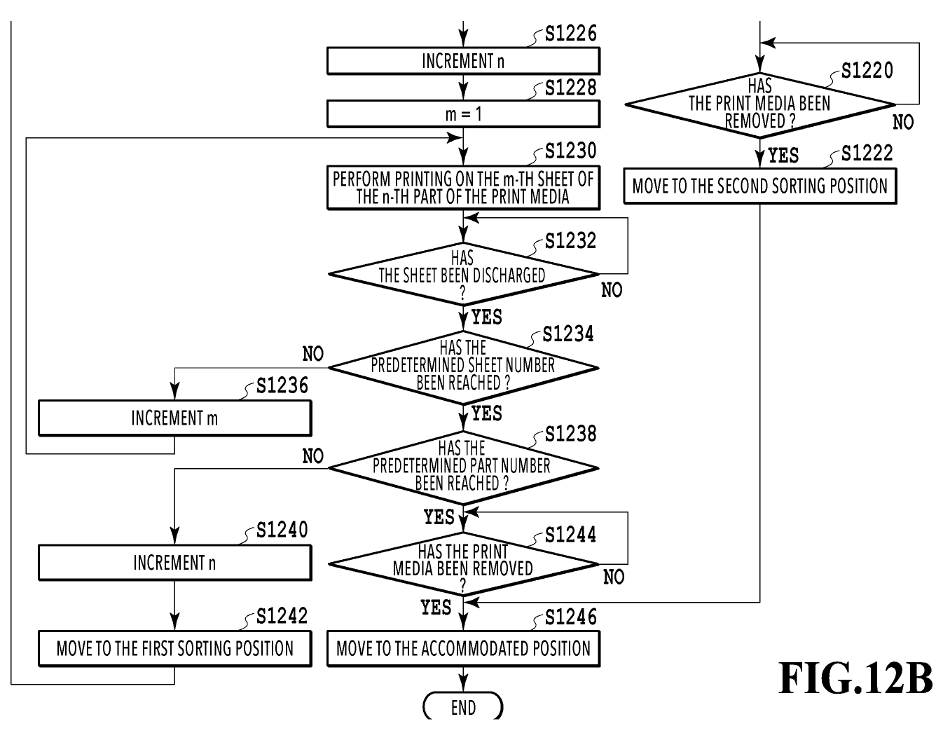

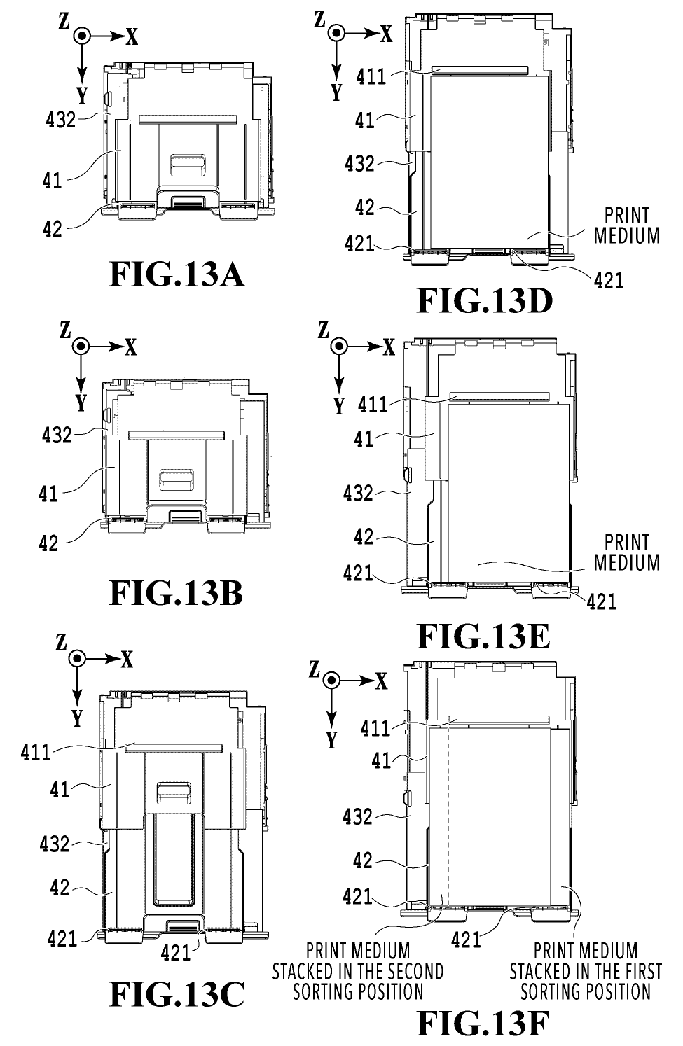

Next, a description is given about the print processing in which, while printing is performed on print media, the print media after printing are sorted in the stacking part 4. FIG. 12 is a flowchart illustrating the details of processing of the print processing in which, while printing is performed on print media, the print media after printing are sorted in the stacking part 4. FIG. 13A to FIG. 13F are diagrams illustrating the states after the stacking part 4 is moved. FIG. 14A to FIG. 14C are diagrams for describing the discharge of print media onto the stacking surface 4a of the stacking part 4, and FIG. 14D is a diagram illustrating the extension amount (the stack position) of the front tray 42 in accordance with the size of the print medium.

The series of processes illustrated in the flowchart of FIG. 12 is performed by the control part 71 loading a program code stored in a program memory (not illustrated in the drawings) of the storage part 72 into a data memory (not illustrated in the drawings) in the storage part 72 and executing it. Alternatively, part or all of the functions in the steps of FIG. 12 may be executed by hardware such as an ASIC (application-specific integrated circuit), an electronic circuit, or the like. In the present specification, the sign "S" in the description of each process in the flowchart indicates a step in the flowchart. Note that in the explanation of the print processing using FIG. 12, a case is described in which a bundle of M sheets of print media is treated as one part, and print processing is executed by the printing apparatus 1 based on a job for executing printing to generate N parts of such bundles of print media.

At the start of the print processing, first, in S1202, the control part 71 moves the rear tray 41 and the front tray 42 to the first sorting position. In S1202, the drive source 44 is rotated in the first direction to move the rear tray 41 and the front tray 42, which are at the initial position (see FIG. 13A), in the −X direction to the first sorting position (see FIG. 13B). Next, in S1204, the control part 71 moves the front tray 42 from the accommodated position to the stack position. In S1204, in the state where the rear tray 41 and the front tray 42 are at the first sorting position, the drive source 44 is further rotated in the first direction, thereby moving the front tray 42 in the +Y direction from the accommodated position to the stack position (see FIG. 13C).

As described above, in the present embodiment, the stack position changes according to the size of the print media. Specifically, the front tray 42 is moved to the position where the length L in the Y direction from the paper discharge roller pair 26 (the abutting surface 411a) to the abutting surfaces 421a substantially matches the size (the length in the Y direction) of printed print media. Therefore, the stack position in a case where printing is performed on the print medium P4 whose length in the Y direction is a predetermined length is located on the downstream side in the +Y direction by ΔY, compared with the stack position in a case where printing is performed on the print medium P5 whose length in the Y direction is shorter than the predetermined length by ΔY (see FIG. 14D).

Therefore, in the present embodiment, the expansion amount of the stacking part 4 varies depending on the size of the print media. Therefore, in S1204, whether or not the front tray 42 has moved to the stack position that is set corresponding to the size of the print medium is determined based on a detection result of a sensor installed in the detection part 73 to detect the position of the stacking part 4 after a predetermined operation. Specifically, for example, based on a detection result of a rotary encoder of the drive source 44, the front tray 42 is moved to the stack position corresponding to the size of the print media. Alternatively, it is also possible to adopt a configuration in which the front tray 42 is moved to the stack position corresponding to the size of the print media based on a detection result of a mechanical switch, a photo sensor, or the like.

Note that the drive transmission part 43 is formed such that, in a state where the rear tray 41 is at the first sorting position, the cam 4312 does not rotate any further even if the driving force resulting from the rotation of the drive source 44 in the first direction is transmitted. Therefore, in S1204, even if the drive source 44 rotates in the first direction in the state where the rear tray 41 and the front tray 42 are at the first sorting position, the rear tray 41 and the front tray 42 do not move in the −X direction from the first sorting position.

Next, in S1206, the control part 71 sets the variable n, which indicates the part number of the bundle of print media to be sorted, to "1." Further, in S1208, the control part 71 sets the variable m, which indicates the sheet number of the print medium to be printed, to "1." Then, in S1210, the control part 71 performs printing on the m-th sheet of the n-th part of the print media. In the printing part 10, a printing operation is performed in which ink is ejected while the print head 3 is moved in the X direction with respect to a predetermined area of the print media conveyed by the conveyance part 2 and supported by the platen 25. Next, after performing a conveying operation in which the conveyance part 2 conveys the print medium by a predetermined amount corresponding to the Y-direction length of the predetermined area, the printing operation is executed again. In this way, the printing part 10 performs printing on the print medium by alternately and repeatedly executing the printing operation and the conveyance operation. Therefore, the print medium is conveyed in the +Y direction during printing as the printing progresses, discharged at the end of the printing, and then stacked onto the stacking part 4, which has expanded to the first sorting position.

Then, in S1212, the control part 71 determines whether or not the print medium has been discharged. In S1212, for example, the determination is made based on a detection result of a sensor installed in the detection part 73 to detect the discharge of the print medium, and the number of discharged print media is counted. The discharged print medium is stacked onto the stacking part 4 at the first sorting position (see FIG. 13D).

At the time print media are discharged, in accordance with the size of the print media, the abutting surfaces 421a are positioned such that the length L to the paper discharge roller pair 26 (the abutting surface 411a) in the Y direction substantially matches the size (the length in the Y direction) of the print media to be discharged. Therefore, during the time printing is performed by the print head 3 on a print medium (see P4 in FIG. 14A), its front edge (the edge on the downstream side in the +Y direction) does not abut on the abutting surfaces 421a in the stacking part 4 (see FIG. 14A).

Then, even at the time the printing by the print head 3 is completed and the rear edge of the print medium (the edge on the upstream side in the +Y direction) reaches the paper discharge roller pair 26, the front edge of the print medium has not yet abutted on the abutting surfaces 421a (see FIG. 14B). Thereafter, right after the rear edge of the print medium is discharged from the paper discharge roller pair 26, the front edge of the print medium abuts on the abutting surfaces 421a, and the rear edge of the print medium faces the abutting surface 411a (see FIG. 14C). As a result, the print medium discharged onto the stacking part 4 is accommodated between the front-edge regulation parts 421 and the rear-edge regulation part 411.

In this way, by moving the front tray 42 to a stack position corresponding to the size of a print medium, the gliding distance from discharge of the print medium from the paper discharge roller pair 26 until the print medium stops on the stacking surface 4a of the stacking part 4 is optimized in accordance with the size of the print medium. That is, the gliding distance becomes shorter depending on the size of print media. Accordingly, disruption of a stack position of discharged print media on the stacking part 4 is suppressed. Further, although the reaction force generated at the time print media abut on the abutting surfaces 421a may cause the print media to move in the −Y direction or tilt in the XY plane, the movement of print media is restricted by the front-edge regulation parts 421 and the rear-edge regulation part 411. This improves alignment of discharged print media on the stacking part 4.

Note that, in order to reduce the impact noise made by print media abutting on the abutting surfaces 421a, the front-edge regulation parts 421 may be configured as elastic members such as rubber, or elastic members may be attached to the abutting surfaces 421a. Further, the surface shape of the abutting surfaces 421a may be a wavelike shape with concave and convex portions extending in the X direction and arranged alternately in the Z direction, thereby suppressing abutting print media from riding up onto the front-edge regulation parts 421. Alternatively, return portions may be formed in the vicinities of the upper end portions of the abutting surfaces 421a to regulate print media abutting on the abutting surfaces 421a from riding up onto the front-edge regulation parts 421.

Further, it is desirable that the height (the length in the Z direction) of the front-edge regulation parts 421 (the abutting surfaces 421a) be set to be equal to or lower than the position at which print media are nipped by the paper discharge roller 26a and the spur 26b. This is to prevent the print media stacked on the stacking part 4 from being drawn into the paper discharge roller pair 26 in a case where double-sided printing is performed. As a countermeasure to prevent print media stacked on the stacking part 4 from being drawn into the paper discharge roller pair 26 during double-sided printing, for example, a sensor may be installed to detect overloading of print media on the stacking part 4.

In the present embodiment, the printing on the first sheet of the first part of print media is started after the rear tray 41 and the front tray 42 are moved to the first sorting position and then the front tray 42 is moved to the stack position; however, there is no such limitation. The above-described movements of the rear tray 41 and the front tray 42 only need to be completed by the time the first sheet of the first part of print media is discharged to the stacking part 4, and thus the movements and the printing on the first sheet of the first part of print media may be executed in parallel. Note that the phrase "by the time the first sheet of the first part of print media is discharged to the stacking part 4" refers, for example, to the time by which the first sheet of the first part of print media is discharged and placed onto the stacking part 4.

Alternatively, for example, as the initial operation after activating the printing apparatus 1, the movement of the rear tray 41 and the front tray 42 to the first sorting position and the movement of the front tray 42 to the stack position may be executed. Or, at the timing the printing apparatus 1 receives a job, the movement of the rear tray 41 and the front tray 42 to the first sorting position and the movement of the front tray 42 to the stack position may be executed.

Thereafter, in S1214, whether or not the discharged print media have reached a predetermined number of sheets is determined. In S1214, whether or not the count of the discharged print media has reached a predetermined number of sheets, which is set in advance, is to be determined. Alternatively, in S1214, it is also possible to determine whether or not the sheet number m has reached a predetermined sheet number. In this case, in S1212, the count of the number of discharged print media is not performed. The predetermined sheet number is set based on information set in the job, for example. That is, in the present embodiment, the predetermined sheet number is "M," and in S1214, whether or not m = M is to be determined.

In S1214, if it is determined that the discharged print media have not reached the predetermined number of sheets, the processing proceeds to S1216, where the control part 71 increments m, and the processing returns to S1210. Further, in S1214, if it is determined that the discharged print media have reached the predetermined number of sheets, the processing proceeds to S1218, where the control part 71 determines whether or not the part number n has reached a predetermined part number. The predetermined part number is set based on information set in the job, for example. That is, in the present embodiment, the predetermined part number is "N", and in S1218, whether or not n = N is to be determined.

In S1218, if it is determined that the part number n has reached the predetermined part number, the processing proceeds to S1220, where the control part 71 determines whether or not the print media have been removed from the stacking part 4. In S1220, the determination is made based on a detection result of a sensor installed in the detection part 73 to detect whether or not any print medium is stacked on the stacking part 4. In S1220, if it is determined that the print media have not been removed from the stacking part 4, the processing of S1220 is performed again. At this time, it is also possible to provide, via the display panel 82 of the operation part 8, a notification to prompt the user to remove the print media from the stacking part 4. Further, in S1220, if it is determined that the print medium has been removed from the stacking part 4, the processing proceeds to S1222, where the rear tray 41 and the front tray 42 are moved to the second sorting position. In S1222, the drive source 44 is rotated in the second direction to move the rear tray 41 and the front tray 42, which are at the first sorting position, in the +X direction to the second sorting position, and then the processing proceeds to S1246 described later.

Further, in S1218, if it is determined that the part number n has not reached the predetermined part number, the processing proceeds to S1224, where the control part 71 moves the rear tray 41 and the front tray 42 to the second sorting position (see FIG. 13E). Since the details of processing of S1224 are the same as those of S1222 described above, the detailed explanations thereof are omitted. Next, in S1226, the control part 71 increments the variable n. Further, in S1228, the control part 71 sets the variable m to "1." Thereafter, in S1230, the control part 71 performs printing on the m-th sheet of the n-th part of the print media. The print medium is conveyed in the +Y direction during printing as the printing progresses, discharged at the end of the printing, and then stacked onto the stacking part 4, which has expanded to the second sorting position. Then, in S1232, the control part 71 determines whether or not the print medium has been discharged. Note that the herein-discharged print medium is to be stacked onto the print medium stacked in the stacking part 4 at the first sorting position, i.e., to be stacked at a position offset in the X direction relative to the print media stacked at the first sorting position (see FIG. 13F).

During printing in S1230, as in the printing in S1210, in accordance with the size of the print media, the abutting surfaces 421a are positioned such that the length L to the paper discharge roller pair 26 (the abutting surface 411a) in the Y direction substantially matches the size of the print media to be discharged. Therefore, right after the rear edge (the edge on the upstream side in the +Y direction) of the print medium is discharged from the paper discharge roller pair 26, the front edge (the edge on the downstream side in the +Y direction) of the print medium abuts on the abutting surfaces 421a, and the rear edge of the print medium faces the abutting surface 411a.

In this way, by moving the front tray 42 to a stack position corresponding to the size of a print medium, the gliding distance from discharge of the print medium from the paper discharge roller pair 26 until the print medium stops on the stacking surface 4a of the stacking part 4 is optimized in accordance with the size of the print medium. Accordingly, disruption of a stack position of discharged print media on the stacking part 4 is suppressed. Further, although the reaction force generated at the time print media abut on the abutting surfaces 421a may cause the print media to move in the −Y direction or tilt in the XY plane, the movement of print media is restricted by the front-edge regulation parts 421 and the rear-edge regulation part 411. This improves alignment of discharged print media.

In the present embodiment, the printing on the first sheet of the n-th part of the print media is performed after the rear tray 41 and the front tray 42 are moved to the second sorting position; however, there is no such limitation. The movements of the rear tray 41 and the front tray 42 to the second sorting position only need to be completed by the time the first sheet of the n-th part of the print media is discharged to the stacking part 4, and thus the movements and the printing on the first sheet of the n-th part of the print media may be executed in parallel. Note that the phrase "by the time the first sheet of the n-th part of the print media is discharged to the stacking part 4" refers, for example, to the time by which the first sheet of the n-th part of the print media is discharged and placed onto the print medium stacked on the stacking part 4.

Thereafter, in S1234, whether or not the discharged print media have reached the predetermined number of sheets is determined. In S1234, if it is determined that the discharged print media have not reached the predetermined number of sheets, the processing proceeds to S1236, where the control part 71 increments m, and the processing returns to S1230. Further, in S1234, if it is determined that the discharged print media have reached the predetermined number of sheets, the processing proceeds to S1238, where the control part 71 determines whether or not the part number n has reached a predetermined part number. Note that since the specific details of processing of S1232 through S1238 described above are the same as those of S1212 through S1218 described above, the detailed explanations thereof are omitted.

In S1238, if it is determined that the part number n has not reached the predetermined part number, the processing proceeds to S1240, where the control part 71 increments n. Then, in S1242, the control part 71 moves the rear tray 41 and the front tray 42 to the first sorting position, and the processing returns to S1208. In S1242, the drive source 44 is rotated in the first direction to move the rear tray 41 and the front tray 42, which are at the second sorting position, in the −X direction to the first sorting position.

In the present embodiment, after moving the rear tray 41 and the front tray 42 to the first sorting position in S1242, the processing returns to S1208, where the printing on the first sheet of the n-th part of the print media is performed; however, there is no such limitation. The movements of the rear tray 41 and the front tray 42 to the first sorting position in S1242 only need to be completed by the time the first sheet of the n-th part of the print media is discharged to the stacking part 4, and thus the movements and the printing on the first sheet of the n-th part of the print media may be executed in parallel.

Further, in S1238, if it is determined that the part number n has reached the predetermined part number, the processing proceeds to S1244, where the control part 71 determines whether or not the print media have been removed from the stacking part 4. Since the details of processing of S1244 are the same as those of S1220 described above, the detailed explanations thereof are omitted. In S1244, if it is determined that the print media have not been removed from the stacking part 4, the processing of S1244 is performed again. At this time, it is also possible to provide, via the display panel 82 of the operation part 8, a notification to prompt the user to remove the print media from the stacking part 4. In S1244, if it is determined that the print media have been removed from the stacking part 4, the processing proceeds to S1246, where the control part 71 moves the front tray 42 from the stack position to the accommodated position, and ends this print processing. Note that at the time of ending the print processing, for example, the rear tray 41 and the front tray 42 in the accommodated position are moved to the initial position (see FIG. 13A).

In S1246, in the state where the rear tray 41 and the front tray 42 are at the second sorting position, the drive source 44 is further rotated in the second direction, thereby moving the front tray 42 in the −Y direction from the stack position to the accommodated position. Note that the drive transmission part 43 is formed such that, in a state where the rear tray 41 is at the second sorting position, the cam 4312 does not rotate any further even if the driving force resulting from the rotation of the drive source 44 in the second direction is transmitted. Therefore, in S1246, even if the drive source 44 rotates in the second direction in the state where the rear tray 41 and the front tray 42 are at the second sorting position, the rear tray 41 and the front tray 42 do not move in the +X direction from the second sorting position.

As described above, in the present embodiment, the control part 71, the drive source 44, and the drive transmission part 43 function as a control unit that controls the movement of the stacking part 4 equipped with the rear tray 41 and the front tray 42.

### Functional Effect

As described above, the printing apparatus 1 includes the stacking part 4 on which print media to be discharged can be stacked, using the rear tray 41 and the front tray 42 that is movable in the Y direction in which print media are discharged. Further, the front tray 42 includes, at its front end, the front-edge regulation parts 421 configured such that the front edge of a print medium to be discharged abuts on the abutting surfaces 421a so that the position of the front edge is regulated. Furthermore, at the time of printing, the front tray 42 is moved to a position where the length from the paper discharge roller pair 26 to the abutting surfaces 421a of the front-edge regulation parts 421 substantially matches the size of the print medium to be used. This optimizes the gliding distance, at the time the print medium is discharged to the stacking part 4, from discharge of the print medium from the paper discharge roller pair 26 until the print medium stops on the stacking surface 4a of the stacking part 4, thereby suppressing disruption of a stack position of discharged print media on the stacking part 4.

Further, in the rear tray 41, the rear-edge regulation part 411 including the abutting surface 411a on which the rear edge of discharged print media can abut is formed on the vertically lower side of the paper discharge roller pair 26. This regulates movement of print media in the direction opposite to the discharge direction and tilt of print media on the stacking surface 4a, which occur due to the reaction force at the time the print media abut on the abutting surfaces 421a. Therefore, it is possible to ensure alignment of discharged print media.

### Second Embodiment

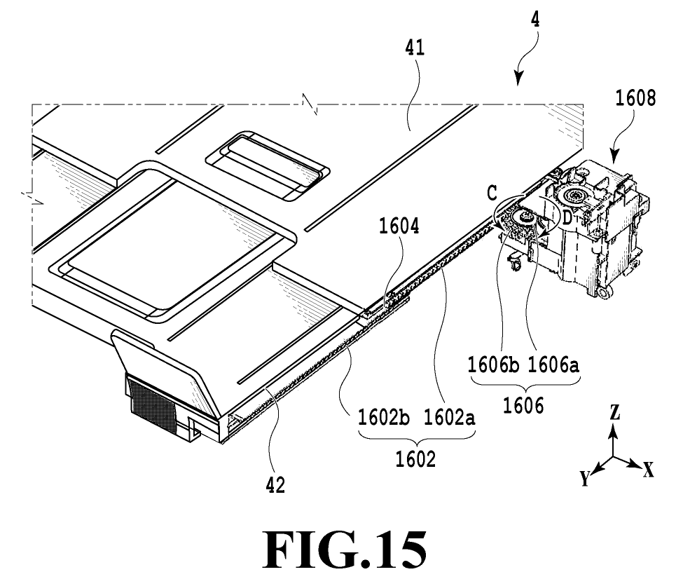

Next, with reference to FIG. 15, a description is given about the printing apparatus according to the second embodiment. In the following description, configurations that are the same or correspond to those of the printing apparatus according to the above-described first embodiment are assigned with the same signs as those used in the above-described first embodiment, thereby omitting a detailed description thereof.

The second embodiment differs from the above-described first embodiment in the aspect that the stacking part 4 is configured to expand and contract in the Y direction via a driving mechanism installed on a side part of the stacking part 4 and not to move in the X direction. Hereinafter, a detailed description is given about the configuration of the driving mechanism of the stacking part 4 according to the present embodiment.

### Driving Mechanism of the Stacking Part

A description is given about the driving mechanism of the stacking part 4 according to the present embodiment. FIG. 15 is a diagram illustrating the driving mechanism for expanding and contracting the stacking part 4 in the Y direction according to the present embodiment. In the present embodiment, the configuration for expanding and contracting the stacking part 4 in the Y direction includes the rack 1602 installed on a side surface of the stacking part 4, and the driving member 1608 equipped with a pinion that meshes with the rack.

More specifically, the rack 1602 is formed on the side surface of the other side (the right side) of the stacking part 4 in the X direction. The rack 1602 includes the first rack part 1602a formed over substantially the entire side surface of the right side of the rear tray 41, and the second rack part 1602b formed over substantially the entire side surface of the right side of the front tray 42. Note that the first rack part 1602a includes the groove part 1604 formed in front of the first tooth. That is, on the right side surface of the rear tray 41, an area without teeth is formed in a part of the front side. Both the first rack part 1602a and the second rack part 1602b are formed with the tooth tips facing to the right. Further, both the first rack part 1602a and the second rack part 1602b are formed with the same tooth pitch.

The housing 9 includes the fixedly-installed driving member 1608 equipped with the gear 1606 that functions as a pinion meshing with the rack 1602. The gear 1606 includes the gear 1606a and the gear 1606b, which are concentric and stacked in the vertical direction (the Z direction). Both the gear 1606a and the gear 1606b are configured with the same pitch and diameter. The gear 1606a, which is positioned above, meshes with the first rack part 1602a, whereas the gear 1606b, which is positioned below, meshes with the second rack part 1602b. Note that in a case where the stacking part 4 is in the accommodated position accommodated within the housing 9, the gear 1606b meshes with the second rack part 1602b, but the gear 1606a is positioned such that its tooth tip is located in the groove part 1604, and does not mesh with the first rack part 1602a.

### Expansion and Contraction of the Stacking Part

In the above-described configuration, in a case where the stacking part 4 expands in the Y direction, a driving motor (not illustrated in the drawings) installed in the driving member 1608 as the drive source rotates in the forward direction, and the driving force generated by the driving motor is transmitted to the gear 1606 via multiple gears (not illustrated in the drawings). Accordingly, the gear 1606a and the gear 1606b rotate in the direction of arrow C. Note that, in addition to the driving motor, the driving member 1608 includes multiple gears for transmitting the driving force generated by the driving motor to the gear 1606.

If the gear 1606a and the gear 1606b rotate in the direction of arrow C, the front tray 42 of the stacking part 4 in the accommodated position moves in the +Y direction due to the second rack part 1602b meshing with the gear 1606b. At the time the stacking part 4 is in the accommodated position, the gear 1606b does not mesh with the first rack part 1602a, and thus the rear tray 41 does not move in the +Y direction.

Then, if the front tray 42 moves a predetermined amount in the +Y direction, the rear tray 41 moves in the +Y direction along with the movement of the front tray 42. Due to this movement of the rear tray 41, the first rack part 1602a begins meshing with the gear 1606a, thereby causing the rear tray 41 to move in the +Y direction via the first rack part 1602a with the rotation of the gear 1606a in the direction of arrow C. Note that, if the rear tray 41 moves in the +Y direction, the front tray 42 also moves in the +Y direction along with the movement of the rear tray 41, thereby causing the front tray 42 to move to the position not overlapping with the gear 1606 in the Y direction. This ends the meshing of the second rack part 1602b and the gear 1606b.

The moving amount of the stacking part 4 in the +Y direction, i.e., the expansion amount, varies according to the size of the print medium used. Note that expansion amount is controlled based on a sensor (not illustrated in the drawings) that can detect the rotation amount of the driving motor or the gears installed in the driving member 1608, for example.

Further, in a case where the stacking part 4 contracts in the Y direction, the driving motor installed in the driving member 1608 rotates in the reverse direction, and the driving force generated by the driving motor is transmitted to the gear 1606 via multiple gears. Accordingly, the gear 1606a and the gear 1606b rotate in the direction of arrow D. If the gear 1606a and the gear 1606b rotate in the direction of arrow D, the rear tray 41 moves in the −Y direction due to the first rack part 1602a meshing with the gear 1606a. At this time, the front tray 42 moves in the −Y direction along with the movement of the rear tray 41 in the −Y direction.

Then, at the time the gear 1606a is positioned in the groove part 1604, the movement of the rear tray 41 in the −Y direction stops, but the second rack part 1602b begins meshing with the gear 1606b. Accordingly, the front tray 42 begins moving in the −Y direction due to the rotation of the gear 1606b, and this movement of front tray 42 in the −Y direction moves both the front tray 42 and the rear tray 41 to the accommodated position. Note that in the present embodiment, the steps for moving to the first sorting position and moving to the second sorting position in the print processing are to be omitted.

### Modification Example

Although not specifically mentioned in the description above, it is also possible to adopt a configuration that allows selection between an automatic mode in which the stacking part 4 automatically expands and contracts using the above-described driving mechanism and a manual mode in which the user manually expands and contracts the stacking part 4. In this case, in the manual mode, for example, the gear 1606 is configured not to mesh with the gears that transmit the driving force in the driving member 1608.

In the description above, the stacking part 4 is configured not to move in the X direction; however, there is no such limitation, and, it is also possible to adopt a configuration in which the stacking part 4 is moved in the X direction using various known technologies. Further, in the description above, both the rear tray 41 and the front tray 42 are configured to be movable in the Y direction; however, there is no such limitation. It is also possible that the rear tray 41 is configured not to move in the Y direction, and only the front tray 42 is configured to move in the Y direction using the above-described driving mechanism.

### Third Embodiment

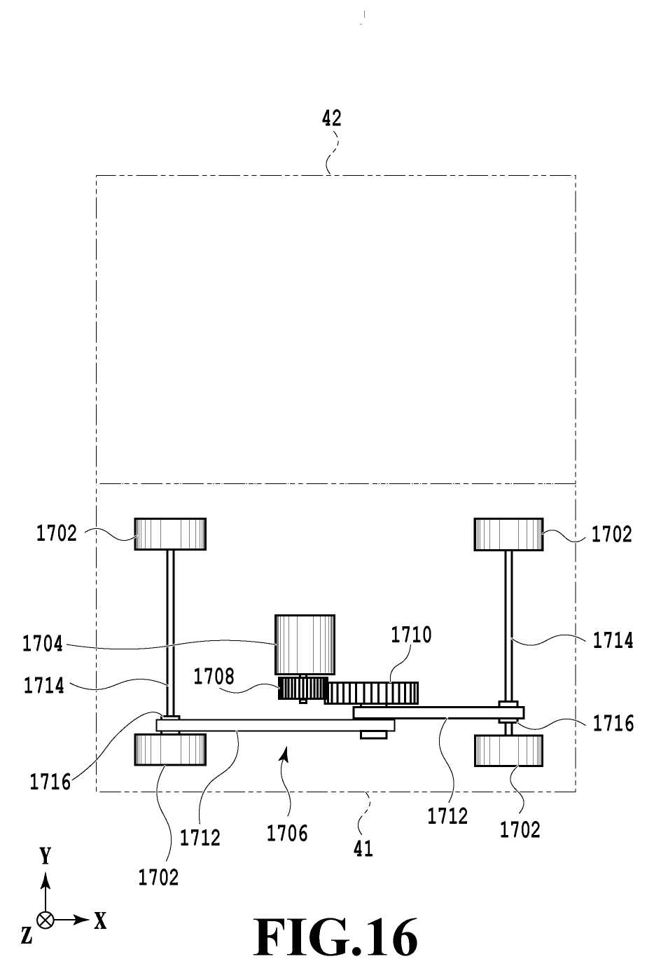

Next, with reference to FIG. 16, a description is given about the printing apparatus according to the third embodiment. In the following description, configurations that are the same or correspond to those of the printing apparatus according to the above-described first embodiment are assigned with the same signs as those used in the above-described first embodiment, thereby omitting a detailed description thereof.

The third embodiment differs from the above-described first embodiment in the aspect that the stacking part 4 is configured to move in the X direction via the driving mechanism and not to expand or contract in the Y direction via that driving mechanism. Hereinafter, a detailed description is given about the configuration of the driving mechanism of the stacking part 4 according to the present embodiment.

### Driving Mechanism of the Stacking Part

A description is given about the driving mechanism of the stacking part 4 according to the present embodiment. FIG. 16 is a diagram illustrating the driving mechanism for moving the stacking part 4 in the X direction according to the present embodiment. As the configuration for moving the stacking part 4 in the X direction, the present embodiment includes the roller 1702 that rotates to enable the rear tray 41 to move in the X direction, and the driving motor 1704 that drives the roller. Note that, in the present embodiment, the front tray 42 is configured to be expandable and contractible with respect to the rear tray 41 only manually.

More specifically, the bottom surface of the rear tray 41 is equipped with the multiple rollers 1702 that allow the rear tray 41 to move in the X direction within the housing 9. In the present embodiment, each roller 1702 is arranged, on the bottom surface of the rear tray 41, at the position that does not restrict the manual expansion and contraction of the front tray 42. The rollers 1702 move, for example, on a rail (not illustrated in the drawings) installed in the housing 9 and extending in the X direction.

Further, the bottom surface of the rear tray 41 is equipped with the driving motor 1704 that is driven under the control of the control part 71, and the transmission part 1706 that transmits the driving force generated by the driving motor 1704 to the rollers 1702. The driving motor 1704 and the transmission part 1706 are also arranged on the bottom surface of the rear tray 41, at the positions that do not restrict the manual expansion and contraction of the front tray 42.

### Movement of the Stacking Part

The driving motor 1704 rotates based on the drive signal from the control part 71, thereby causing the drive gear 1708 to rotate, and this drive is transmitted to the drive transmission gear 1710. Then, the rotation of the drive transmission gear 1710 is transmitted via the drive transmission belt 1712 to the gear 1716, which is coupled to the shaft 1714 connecting the rollers 1702. Accordingly, as the shaft 1714 rotates, the rollers 1702 rotate in conjunction with the rotation of the shaft 1714. Further, this rotation of the rollers 1702 causes the rear tray 41 to move in the +X direction and the −X direction. The moving direction of the rear tray 41 is changed according to the rotation direction of the driving motor 1704. For example, if the driving motor 1704 rotates in the forward direction, the rear tray 41 moves in the +X direction, and if it rotates in the reverse direction, the rear tray 41 moves in the −X direction.

In the present embodiment, in the step of executing the processes of moving the front tray 42 to the stack position and the accommodated position during the print processing, a notification prompting the user to move the front tray 42 to the stack position or the accommodated position is provided on the display panel 82 of the operation part 8.

### Modification Example

In the description above, the bottom surface of the rear tray 41 is equipped with the rollers 1702, the driving motor 1704, and the transmission part 1706 configured with the drive transmission gear 1710 and the like; however, there is no such limitation. For example, it is also possible to install a moving part configured with these configurations to be movable in the X direction, and the rear tray 41 is fixedly arranged on that moving part.

In the description above, the stacking part 4 is configured not to expand or contract in the Y direction automatically; however, there is no such limitation, and it is also possible to adopt a configuration in which the stacking part 4 expands or contracts automatically, using various known technologies.

### Fourth Embodiment

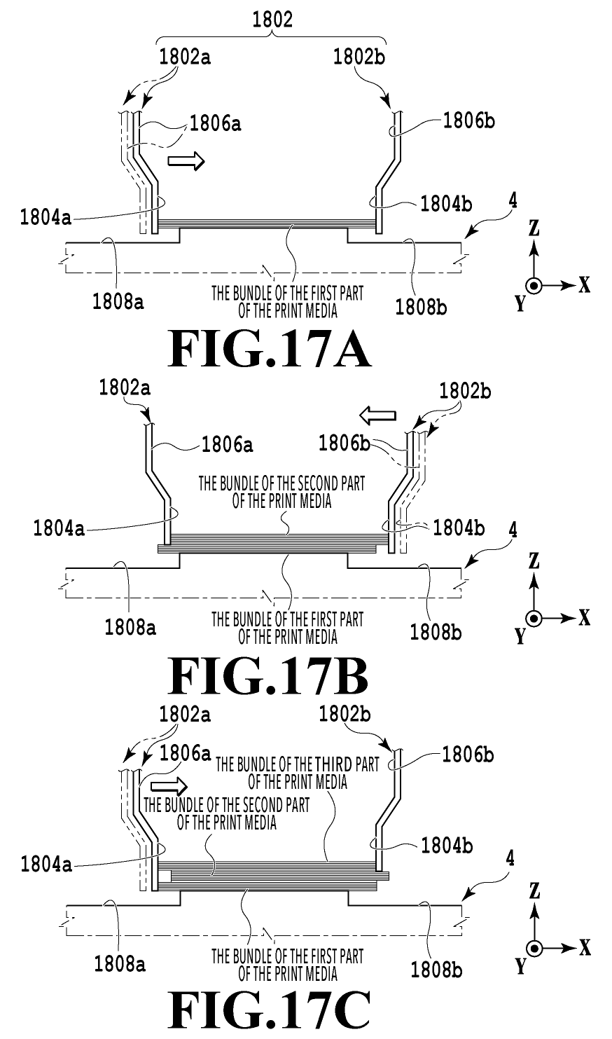

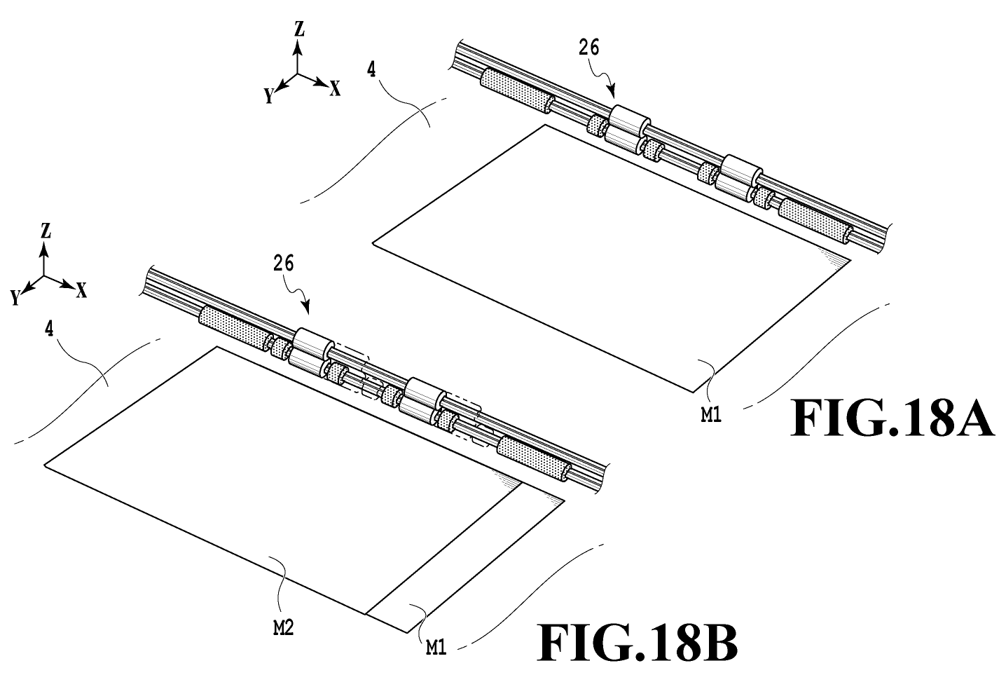

Next, with reference to FIG. 17A to FIG. 18B, a description is given about the printing apparatus according to the fourth embodiment. In the following description, configurations that are the same or correspond to those of the printing apparatus according to the above-described first embodiment are assigned with the same signs as those used in the above-described first embodiment, thereby omitting a detailed description thereof.

The fourth embodiment differs from the above-described first embodiment in that the print media to be discharged are sorted by a configuration different from the stacking part 4. Hereinafter, a detailed description is given about the configuration for sorting the print media to be discharged.

### Configuration for Sorting the Print Media to be Discharged

FIG. 17A to FIG. 17C are diagrams describing an alignment member, which is an example of the configuration for sorting the print media to be discharged. FIG. 17A is a diagram illustrating the alignment member sorting a bundle of the first part of the print media. FIG. 17B is a diagram illustrating the alignment member sorting a bundle of the second part of the print media. FIG. 17C is a diagram illustrating the alignment member sorting a bundle of the third part of the print media.

In the present embodiment, the printing apparatus 1 includes the alignment member 1802 that is capable of aligning the X-direction ends of the print media discharged from the paper discharge roller pair 26. The alignment member 1802 includes the pair of alignment members 1802a and 1802b, and the alignment member 1802a and the alignment member 1802b are arranged to face each other such that their spacing in the X direction can be changed.

The alignment members 1802a and 1802b are formed of plate-like bodies. The alignment part 1804a for aligning the print media discharged to the stacking part 4 is formed at the lower part of the alignment member 1802a, and the alignment part 1804b that cooperates with the alignment part 1804a to align the print media is formed at the lower part of the alignment member 1802b. The alignment parts 1804a and 1804b have flat surfaces that face each other. The multiple print media stacked in the stacking part 4 are pressed at their X-direction edges by the alignment parts 1804a and 1804b, so that their positions in the X direction are aligned.

The alignment member 1802a includes the relief part 1806a formed above the alignment part 1804a and positioned on one side in the X direction relative to the alignment part 1804a. Further, the alignment member 1802b includes relief part 1806b formed above the alignment part 1804b and positioned on the other side in the X direction relative to the alignment part 1804b. Accordingly, the relief parts 1806a and 1806b have a wider space in the X direction than the space of the alignment parts 1804a and 1804b. Further, the relief parts 1806a and 1806b become narrower in the X-direction width as they extend downward from predetermined positions, and are connected at their lower ends to the alignment parts 1804a and 1804b, respectively. Thus, in the alignment member 1802, the print media discharged between the relief parts 1806a and 1806b are likely to be guided between the alignment parts 1804a and 1804b.

The alignment member 1802 is arranged in the housing 9 so as to be capable of executing the later-described various operations. The operations of the alignment member 1802 are controlled by the control part 71. The alignment member 1802 may have a detachable configuration or a non-detachable configuration.

On one side in the X direction of the upper surface for stacking the print media in the stacking part 4, the recess part 1808a into which the tip of the alignment member 1802a can enter extends in the X direction. Further, on the other side of that upper surface in the X direction, the recess part 1808b into which the tip of the alignment member 1802b can enter extends in the X direction. In the present embodiment, the recess parts 1808a and 1808b are formed in the rear tray 41.

In a case where printing is executed on the first part of the print media in the print processing, the alignment members 1802a and 1802b stand by at the first receiving position where the alignment parts 1804a and 1804b are spaced apart by a predetermined amount wider than the width (the length in the X direction) of the print media. At this time, the front tray 42 is at the stack position. Further, at this time, the tips of the alignment members 1802a and 1802b have entered into the recess parts 1808a and 1808b, respectively (see FIG. 17A).

The print media discharged from the paper discharge roller pair 26 enter between the relief parts 1806a and 1806b of the alignment members 1802a and 1802b that are standing by at the first receiving position, and are discharged onto the upper surface of the stacking part 4 by their own weight. At this time, in the alignment members 1802a and 1802b, the relief parts 1806a and 1806b, which are spaced apart widely in the X direction, receive the print media that are discharged with some variation in position in the X direction, and guide the print media into the space between the alignment parts 1804a and 1804b. Then, after the end of the printing of the first part, the alignment member 1802a is moved in the +X direction so as to narrow the space between the alignment parts 1804a and 1804b, such that the alignment members 1802a and 1802b press and align the bundle of print media stacked on the stacking part 4 in the +X direction.

Next, at the time of transition to the printing of the second part, the alignment members 1802a and 1802b are moved to the second receiving position that is shifted by a predetermined amount in the +X direction relative to the first receiving position for the first part. At this time, the alignment member 1802a is positioned so that its tip is on the print media of the first part, whereas the alignment member 1802b is in the state where its tip has entered into the recess part 1808b (see FIG. 17B). Further, the print media discharged from the paper discharge roller pair 26 enter between the relief parts 1806a and 1806b of the alignment members 1802a and 1802b that are standing by at the second receiving position, and are discharged onto the bundle of the first part of print media by their own weight. Then, after the end of the printing of the second part, the alignment member 1802b is moved in the −X direction so as to narrow the space between the alignment parts 1804a and 1804b, such that the alignment members 1802a and 1802b press and align the bundle of print media stacked on the bundle of the first part of the print media in the −X direction.

Furthermore, at the time of transition to the printing of the third part, the alignment members 1802a and 1802b are moved to the first receiving position. At this time, the alignment member 1802b is positioned so that its tip is on the print media of the second part, whereas the alignment member 1802a is in the state where its tip has entered into the recess part 1808a (see FIG. 17C). Further, the print media discharged from the paper discharge roller pair 26 enter between the relief parts 1806a and 1806b of the alignment members 1802a and 1802b that are standing by at the first receiving position, and are discharged onto the bundle of the second part of the print media by their own weight. Then, after the end of the printing of the third part, the alignment member 1802a is moved in the +X direction so as to narrow the space between the alignment parts 1804a and 1804b, such that the alignment members 1802a and 1802b press and align the bundle of print media stacked on the bundle of the second part of the print media in the +X direction. In this way, the printing apparatus 1 is capable of sorting the bundles of print media according to the part number.

### Another Configuration for Sorting the Print Media to be Discharged

Moreover, the configuration for sorting the print media to be discharged is not limited to the alignment members 1802 described above. For example, the paper discharge roller pair 26 may be configured to be movable in the direction orthogonal to the discharge direction of the print media, so that sorting can be performed by shifting the position of the print media in at least two locations at the time of discharging to the stacking part 4 (see FIGS. 18A and 18B). FIG. 18A and FIG. 18B are diagrams describing another configuration for sorting the print media to be discharged, with FIG. 18A describing the discharge at the first position, and FIG. 18B describing the discharge at the second position.

Specifically, the paper discharge roller pair 26 is configured to be movable in the X direction. Further, in a case of discharging the print media M1 of an odd-numbered part, the paper discharge roller pair 26 moves, while discharging the print media M1, to the first position that is located relatively on the right side, for example, and then the print media M1 are discharged to the stacking part 4. Accordingly, the print media M1 are to be discharged to the location corresponding to the first position in the stacking part 4 (see FIG. 18A). Moreover, in a case of discharging the print media M2 of an even-numbered part, the paper discharge roller pair 26 moves, while discharging the print media M2, to the second position that is located relatively on the left side, for example, and then the print media M2 are discharged to the stacking part 4. Accordingly, the print media M2 are to be discharged to the location corresponding to the second position in the stacking part 4 (see FIG. 18B). Note that various known technologies can be used for the specific configuration for moving the paper discharge roller pair 26 to different positions at the time of discharging print media according to the part number, and thus a detailed explanation thereof is omitted.

### Other Embodiments

Note that the above-described embodiments may be modified as shown in the following (1) through (11).

(1) Although not specifically described in the above embodiments, in the printing apparatus 1, the print processing that performs printing on print media and sorts the print media after printing (see FIG. 12) and the print processing that does not execute the sorting can be selected based on an input from the operation part 8 or the like. In a case of the print processing that does not execute the sorting, for example, after moving to the first sorting position, the print media after printing continue to be discharged in the state where the front tray 42 has been moved to the stack position. Further, in the case of the print processing that does not execute the sorting, for example, if it is determined in S1218 that the part number n has not reached the predetermined part number, the processing proceeds to S1240. Furthermore, in the case of the print processing that does not execute the sorting, for example, S1202 and S1222 may be omitted.

Note that in the above-described embodiments, the case in which the instruction "Sort into N parts for every M sheets" is input by a job or the operation part 8 is described, using the flowchart of FIG. 12. However, in actual printing operations, even in a case where M and N are known, there may be a designation not to perform sorting. For such cases, a configuration for switching whether or not to transmit the driving force of the drive source 44 to the engagement part 4333 is installed in advance, and in a case where sorting is not performed, the stacking part 4 may be controlled not to move between the first sorting position and the second sorting position.

(2) In the above-described embodiments, the drive transmission part 43 is formed such that, in a state where the rear tray 41 is positioned at the first sorting position, the cam 4312 does not rotate any further even if the driving force resulting from the rotation of the drive source 44 in the first direction is transmitted. However, the drive transmission part 43 is not limited to this configuration. For example, the drive transmission part 43 may be formed such that, in a state where the rear tray 41 is positioned at a predetermined position on one side in the X direction relative to the first sorting position, the cam 4312 does not rotate any further even if the driving force resulting from the rotation of the drive source 44 in the first direction is transmitted. In this case, in the print processing of FIG. 12, after moving the rear tray 41 to the predetermined position, the drive source 44 is further rotated in the first direction to move the front tray 42 from the accommodated position to the stack position. Then, the drive source 44 is rotated in the second direction, thereby moving the rear tray 41 in the +X direction to the first sorting position. At this time, the position of the rear tray 41 is determined based on a detection result of a sensor installed in the detection part 73 to detect the position of the stacking part 4 after a predetermined operation.

(3) In the above-described embodiments, the drive transmission part 43 is formed such that, in a state where the rear tray 41 is at the second sorting position, the cam 4312 does not rotate any further even if the driving force resulting from the rotation of the drive source 44 in the second direction is transmitted. However, the drive transmission part 43 is not limited to this configuration. For example, the drive transmission part 43 may be formed such that, in a state where the rear tray 41 is at a predetermined position on the other side in the X direction relative to the second sorting position, the cam 4312 does not rotate any further even if the driving force resulting from the rotation of the drive source 44 in the second direction is transmitted.

(4) In the above-described embodiments, in the accommodated position, a partial area on the end portion 42a side of the front tray 42 protrudes forward in the Y direction from the housing 9 (see FIG. 6A); however, there is no such limitation. It is also possible that the front tray 42 is configured not to protrude forward from the housing 9 in the accommodated position. That is, in this case, the front tray 42 is completely accommodated within the housing 9 in the accommodated position. Further, in the above-described embodiments, the stacking part 4 sorts the ejected print media by stacking them at two locations, i.e., the first sorting position and the second sorting position; however, the positions for sorting are not limited to the two locations. For example, it is also possible to sort discharged print media at three or more different locations in the X direction.

(5) In the above-described embodiments, the printing apparatus 1 is what is termed as a serial-scan type printing apparatus that performs printing by ejecting ink, while moving the print head 3 in the X direction, onto a print medium being conveyed; however, there is no such limitation. The printing apparatus applicable to the present disclosure may be what is termed as a line-type printing apparatus that performs printing on a print medium conveyed in the Y direction using a print head capable of ejecting ink within a range corresponding to a printable size of print medium with respect to the X direction.

(6) In the above-described embodiments, the first sorting position is set such that the center position Os of the stacking part 4 in the X direction is located on one side in the X direction relative to the center position Om of the print media to be discharged, and the second sorting position is set such that the center position Os is located on the other side in the X direction relative to the center position Om. However, the first sorting position and the second sorting position are not limited to this. For example, either the first sorting position or the second sorting position may be set such that the center position Os coincides with the center position Om. Further, in the above-described embodiments, the initial position during the non-printing time in which printing is not performed is set to the position where the center position Os of the stacking part 4 coincides with the center position Om of the print media to be discharged; however, there is no such limitation. The initial position may be set to the first sorting position, the second sorting position, or a predetermined position other than the first sorting position and the second sorting position.

(7) In the above-described embodiments, upon removing the print media from the stacking part 4, the stacking part 4 is moved in the +X direction, and the front tray 42 is moved from the stack position to the accommodated position; however, there is no such limitation. After the print media are removed from the stacking part 4, the user may manually move the front tray 42 from the stack position to the accommodated position. In this case, although the process in which the user moves the front tray 42 after removing the print media is added, the user's burden is relatively small since the user only needs to push the front tray 42 in this process, and thus usability is not significantly reduced.

(8) In the above-described embodiments, the case where the instruction "Sort into N parts for every M sheets" is set in the job is described. However, the job may also be in a form where a command to change the sorting position is interposed between the image data of a predetermined page and the image data of the next page. In this case, the control part 71 may sequentially execute operations in accordance with the received command, such as printing and discharging according to the image data of the predetermined page, changing the sorting position, and printing and discharging according to the image data of the next page.

(9) In the above-described embodiments, the rear tray 41 is configured to have the rear-edge regulation part 411 including the abutting surface 411a that faces the rear edge of discharged print media and can abut on the rear edge; however, there is no such limitation. The rear tray 41 may be configured without the rear-edge regulation part 411.

(10) Although not specifically described in the above embodiments, the front-edge regulation parts 421 may have any configuration as long as the state in which the abutting surfaces 421a are erected so as to be perpendicular to the stacking surface 4a of the stacking part 4 is maintained. Therefore, the front-edge regulation parts 421 may be fixedly formed on the front tray 42, for example, in the state in which the abutting surfaces 421a are erected so as to be perpendicular to the stacking surface 4a. Further, the front-edge regulation parts 421 may be formed on the front tray 42, for example, so as to be changeable between a first posture, in which the abutting surfaces 421a are perpendicular to the stacking surface 4a, and a second posture, in which the front-edge regulation parts 421 are inclined forward from their upper end portions. That is, in the first posture, the angle formed between the abutting surfaces 421a and the stacking surface 4a is 90°, and in the second posture, the angle formed between the abutting surfaces 421a and the stacking surface 4a is an obtuse angle. Since the front-edge regulation parts 421 can be in the second posture, at the time of taking out the print media stacked on the stacking surface 4a of the stacking part 4, the front-edge regulation parts 421 are less likely to interfere with the print media, thereby improving workability.

In a case where the front-edge regulation parts 421 are configured to be changeable between the first posture and the second posture, the configuration is such that, at least in the first posture, the state in which the front-edge regulation parts 421 are perpendicular to the stacking surface 4a can be maintained unless a force equal to or greater than a predetermined level is applied. Further, in this case, for example, the front-edge regulation parts 421 are configured to be revolvable, on the stacking surface 4a of the front tray 42, about a shaft portion extending in the X direction. Note that various known technologies can be applied to a specific configuration for enabling the front-edge regulation parts 421 to be in the first posture and the second posture. Further, in the second posture, it is sufficient that the front-edge regulation parts 421 are unlikely to interfere at the time of taking out print media from the stacking part 4, and an angle formed with the stacking surface 4a is set as appropriate. That is, the front-edge regulation parts 421 may be such that the abutting surfaces 421a are at an obtuse angle with respect to the stacking surface 4a, may be such that the abutting surfaces 421a are at an angle parallel to the stacking surface 4a, or may be such that the abutting surfaces 421a are at an angle greater than 180° with respect to the stacking surface 4a. That is, in the second posture, it is sufficient that the abutting surfaces 421a are at an angle greater than a right angle with respect to the stacking surface 4a.

(11) The above-described embodiments and various forms shown in (1) through (10) may be combined as appropriate.

According to the present disclosure, it is possible to suppress disruption of a stack position of discharged print media.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-025833, filed February 20, 2025, which is hereby incorporated by reference herein in its entirety.

What is claimed is:

1. A printing apparatus comprising:
a discharge unit configured to discharge a print medium in a first direction;
a stacking unit having a stacking surface and configured to extend and contract in the first direction and to stack the print medium discharged from the discharge unit on the stacking surface;
a first regulation unit arranged in the stacking unit, on a downstream side in the first direction of the stacking unit, and configured to regulate a position of a front edge of the print medium discharged from the discharge unit; and
a control unit configured to control extension of the stacking unit prior to discharge of the print medium, in accordance with a size of the print medium to be discharged from the discharge unit.

2. The printing apparatus according to claim 1,
wherein the control unit is configured to extend the stacking unit to a position at which a length from the discharge unit to the first regulation unit substantially matches a length in the first direction of the print medium discharged from the discharge unit.

3. The printing apparatus according to claim 1,
wherein the first regulation unit has an abutting surface fixedly arranged perpendicular to the stacking surface and onto which the print medium discharged from the discharge unit abuts.

4. The printing apparatus according to claim 1,
wherein the first regulation unit has an abutting surface and is arranged so as to be changeable between a first posture, in which the abutting surface on which the print medium discharged from the discharge unit abuts is perpendicular to the stacking surface, and a second posture, in which the abutting surface forms an angle greater than a right angle with respect to the stacking surface.

5. The printing apparatus according to claim 1, further comprising
a second regulation unit arranged in the stacking unit and configured to regulate a position of arear edge of the print medium discharged from the discharge unit.

6. The printing apparatus according to claim 5,
wherein the second regulation unit is arranged vertically below the discharge unit.

7. The printing apparatus according to claim 1,
wherein the stacking unit includes:
a first stacking part configured to allow the stacking unit to move in a second direction intersecting with the first direction; and
a second stacking part in which the first regulation unit is arranged, the second stacking part being configured to be movable in the first direction relative to the first stacking part, and
wherein the control unit is configured to control movement of the second stacking part to control extension of the stacking unit, and is configured to control movement of the first stacking part.

8. The printing apparatus according to claim 7,
wherein the first stacking part includes a second regulation unit configured to regulate a position of a rear edge of the print medium discharged from the discharge unit.

9. The printing apparatus according to claim 1,
wherein the control unit is configured to change an extension amount of the stacking unit in accordance with a usage environment.

10. The printing apparatus according to claim 1,
wherein the control unit is configured to change an extension amount of the stacking unit in accordance with a type of the print medium.

11. The printing apparatus according to claim 1,
wherein the control unit is configured to change an extension amount of the stacking unit in accordance with an amount of ink applied to the print medium.

12. The printing apparatus according to claim 1,
wherein the first regulation unit is formed of an elastic member.

13. The printing apparatus according to claim 1,
wherein, in the first regulation unit, an elastic member is attached to a surface on which the print medium discharged from the discharge unit abuts.
